(19) United States
(12) Patent Application Publication
(10) Pub. No.: US 2024/0048780 A1
(43) Pub. Date: Feb. 8, 2024

(54) LIVE BROADCAST METHOD, DEVICE, STORAGE MEDIUM, ELECTRONIC EQUIPMENT AND PRODUCT

(71) Applicant: Zhuhai Prometheus Vision Technology Co., LTD, Zhuhai, Guangdong (CN)

(72) Inventors: Yu ZHANG, Zhuhai, Guangdong (CN); Dongfan LUO, Zhuhai, Guangdong (CN); Zhijing SHAO, Zhuhai, Guangdong (CN); Wei SUN, Zhuhai, Guangdong (CN)

(21) Appl. No.: 18/015,117

(22) PCT Filed: Dec. 5, 2022
(86) PCT No.: PCT/CN2022/136581

§ 371 Date: Jan. 9, 2023

(30) Foreign Application Priority Data
Aug. 4, 2022 (CN) 202210934650.8

(51) Int. Cl. H04N 21/2187; G06T 17/00; G06V 10/764; H04N 13/388; H04N 21/475

(52) U.S. Cl. CPC H04N 21/2187; G06T 17/00; G06V 10/764; H04N 13/388; H04N 21/4758

(57) ABSTRACT

A live broadcast method is provided. The live broadcast method includes: obtaining a volumetric video, and the volumetric video is configured to display a live broadcast behavior of a 3D live object; obtaining a 3D virtual scene, and the 3D virtual scene is configured to display a 3D scene content; combining the volumetric video and the 3D virtual scene to obtain a 3D live broadcast content including the live broadcast behavior and the 3D scene content; and generating a 3D live broadcast screen based on the 3D live broadcast content, and the 3D live broadcast screen is configured to play on a live broadcast platform. A live broadcast device, a storage medium, and an electronic equipment and a product is also provided. The present disclosure can effectively improve the effect of virtual live broadcast.

The present disclosure claims the priority of a Chinese patent disclosure filed with the Chinese patent office on Aug. 4, 2022, the disclosure number is 202210934650.8, and the invention title is “live broadcast method, device, storage medium, electronic equipment and product”, the entire content of which is incorporated into the present disclosure by reference.

### TECHNICAL FIELD

The present disclosure relates to a field of internet technology, and more particularly to a live broadcast method, a device, a storage medium, an electronic equipment and a product.

### BACKGROUND

Live broadcast has developed into an important part of the current Internet, and there is a demand for virtual live broadcast in some scenarios. Currently, in several related techniques, a 2D (two-dimensional) plane video about a live broadcast object is superimposed on a 3D (three-dimensional) virtual scene to form a pseudo 3D content source for virtual live broadcast. In these methods, users can only watch the 2D live broadcast screen about the live broadcast content, resulting in poor live broadcast effect. In some other related techniques, to create a 3D model of a live broadcast object, it is necessary to create action data for the 3D model and superimpose it on a 3D virtual scene through a complex overlay method to form a 3D content source. In these ways, the performance of the content source for the live content is usually poor, and the actions and behaviors in the live broadcast screen appear particularly mechanical.

Therefore, the current virtual live broadcast methods all have a problem of poor virtual live broadcast effect.

### SUMMARY

The present disclosure provides a live broadcast method and a related device, which effectively improve the effect of virtual live broadcast.

Embodiments of the present disclosure provides following technical solutions:

According to an embodiment of the present disclosure, a live broadcast method is provided, the live broadcast method includes: obtaining a volumetric video, and the volumetric video is configured to display a live broadcast behavior of a 3D live object; obtaining a 3D virtual scene, and the 3D virtual scene is configured to display a 3D scene content; combining the volumetric video and the 3D virtual scene to obtain a 3D live broadcast content including the live broadcast behavior and the 3D scene content; and generating a 3D live broadcast screen based on the 3D live broadcast content, and the 3D live broadcast screen is configured to play on a live broadcast platform.

According to an embodiment of the present disclosure, a live broadcast device is provided, the live broadcast device includes: a video obtaining module, configured to obtain a volumetric video, and the volumetric video is configured to display a live broadcast behavior of a 3D live object; a scene obtaining module, configured to obtain a 3D virtual scene, and the 3D virtual scene is configured to display a 3D scene content; a combining module, configured to combine the volumetric video and the 3D virtual scene to obtain a 3D live broadcast content including the live broadcast behavior and the 3D scene content; and a live broadcast module, configured to generate a 3D live broadcast screen based on the 3D live broadcast content, and the 3D live broadcast screen is configured to play on a live broadcast platform.

In some embodiments of the present disclosure, the live broadcast module includes: a playing unit, configured to play the 3D live broadcast content; and a recording unit, configured to transform according to a target angle in a 3D space, and record a video screen of a played 3D live broadcast content to obtain the 3D live broadcast screen.

In some embodiments of the present disclosure, a virtual camera track is disposed on the 3D live broadcast content; the recording unit is configured to transform a recording angle in the 3D space following the virtual camera track, and record the video screen of the 3D live broadcast content to obtain the 3D live broadcast screen.

In some embodiments of the present disclosure, the recording unit is configured to transform a recording angle in the 3D space following a gyroscope, and record the video screen of the 3D live broadcast content to obtain the 3D live broadcast screen.

In some embodiments of the present disclosure, the recording unit is configured to transform a recording angle in the 3D space according to a change operation of a viewing angle sent by a live client in the live platform, and record the video screen of the played 3D live broadcast content to obtain the 3D live broadcast screen.

In some embodiments of the present disclosure, the 3D live broadcast content includes a predetermined 3D content and at least one virtual interactive content; the playing unit is configured to play the predetermined 3D content in the 3D live broadcast content; and in response to detecting an interaction trigger signal in the live broadcast platform, play the virtual interaction content corresponding to the interaction trigger signal relative to the predetermined 3D content.

In some embodiments of the present disclosure, the 3D live broadcast content includes a predetermined 3D content; the 3D live broadcast screen is played in the live broadcast room on the live broadcast platform; the playing unit is configured to play the predetermined 3D content in the 3D live broadcast content; and in response to detecting that a user has joined the live broadcast room, display an avatar of the user at a predetermined position relative to the predetermined 3D content.

In some embodiments of the present disclosure, the device further includes an adjustment unit, the adjustment unit is configured to in response to detecting a content adjustment signal in the live broadcast platform, adjust and play the predetermined 3D content.

In some embodiments of the present disclosure, the predetermined 3D content includes a virtual 3D live broadcast object in the volumetric video; the content adjustment signal includes an object adjustment signal; the adjustment unit is configured to in response to detecting the object adjustment signal in the live broadcast platform, dynamically adjust the virtual 3D live broadcast object.

In some embodiments of the present disclosure, the 3D live broadcast screen is played in the live broadcast room on the live broadcast platform; the device further includes an signal determination unit, the signal determination unit is configured to obtain interaction information in the live broadcast room; and classify the interaction information to obtain an event trigger signal in the live broadcast platform, and the event trigger signal includes at least one of an interaction trigger signal and a content adjustment signal.

In some embodiments of the present disclosure, the combining module includes a first combining unit, configured to adjust the volumetric video and the 3D virtual scene according to the combined adjustment operation of the volumetric video and the 3D virtual scene; and in response to a combination confirmation operation, combine the volumetric video with the 3D virtual scene to obtain at least one 3D live broadcast content including the live broadcast behavior and the 3D scene content.

In some embodiments of the present disclosure, the combining module includes a second combining unit, configured to obtain a volumetric video description parameter of the volumetric video; obtain a virtual scene description parameter of the 3D virtual scene; jointly analyze the volumetric video description parameter and the virtual scene description parameter to obtain at least one content combination parameter; and combine the volumetric video and the 3D virtual scene according to the content combination parameter to obtain at least one 3D live broadcast content including the live broadcast behavior and the 3D scene content.

In some embodiments of the present disclosure, the second combining unit is configured to obtain a terminal parameter of a terminal used by a user in the live broadcast platform and a user description parameter of the user; and jointly analyze the volumetric video description parameter, the virtual scene description parameter, the terminal parameter, and the user description parameter to obtain at least one content combination parameter.

In some embodiments of the present disclosure, the 3D live broadcast content is at least one, and different 3D live broadcast contents are configured to generate 3D live broadcast screen recommended to users of different categories.

According to an embodiment of the present disclosure, a live broadcast method is provided, the live broadcast method includes: in response to a live room opening operation, displaying a live broadcast room interface, and playing a 3D live broadcast screen in the live broadcast room interface, and the 3D live broadcast screen is generated according to the live broadcast method described in any one of the foregoing embodiments.

According to an embodiment of the present disclosure, a live broadcast device is provided, the live broadcast device includes: a live room display module, configured to in response to a live room opening operation, display a live broadcast room interface, and play a 3D live broadcast screen in the live broadcast room interface, and the 3D live broadcast screen is generated according to the live broadcast method described in any one of the foregoing embodiments.

In some embodiments of the present disclosure, the live room display module is configured to: displaying a live broadcast client interface, and displaying at least one live broadcast room in the live broadcast client interface; and in response to the live room opening operation for a target live broadcast room in the at least one live broadcast room, displaying the live broadcast room interface of the target live broadcast room.

In some embodiments of the present disclosure, the live room display module is configured to: in response to the live room opening operation, displaying the live broadcast room interface, and displaying an initial 3D live broadcast screen in the live broadcast room interface, and the initial 3D live broadcast screen is obtained by recording a video screen of the predetermined 3D content played in the 3D live broadcast content; and in response to an interactive content triggering operation on the live broadcast room interface, displaying an interactive 3D live broadcast screen in the live broadcast room interface, and the interactive 3D live broadcast screen is obtained by recording a video screen of a played predetermined 3D content and a virtual interactive content triggered by the interactive content triggering operation, and the virtual interactive content belongs to the 3D live broadcast content.

In some embodiments of the present disclosure, the live room display module is configured to: in response to a user joining the live broadcast room corresponding to the live broadcast room interface, displaying a subsequent 3D live broadcast screen in the live broadcast room interface, and the subsequent 3D live broadcast screen is obtained by recording a video screen of the played predetermined 3D content and an avatar of the user who joined the live broadcast room.

In some embodiments of the present disclosure, the live room display module is configured to: in response to the interactive content triggering operation on the live broadcast room interface, displaying a transformed 3D live broadcast screen in the live broadcast room interface, and the transformed 3D live broadcast screen is obtained by recording a video screen of the predetermined 3D content adjusted and played, and an adjustment and playing of the 3D content is triggered by the interactive content triggering operation.

In some embodiments of the present disclosure, the device further includes a voting module, the voting module is configured to: in response to a voting operation for the live broadcast room interface, sending voting information to a target device, wherein a direction of a live broadcast content of a live broadcast room corresponding to the live broadcast room interface is determined by the target device according to the voting information.

According to another embodiment of the present disclosure, a computer readable storage medium is provided. A computer program is stored in the computer readable storage medium, and when the computer program is executed by a processor of a computer, the computer is caused to execute the method of the embodiments of the present disclosure.

According to another embodiment of the present disclosure, an electronic device is provided. The electronic device includes a memory, configured to store a computer program; and a processor, configured to read the computer program stored in the memory to perform the method of the embodiments of the present disclosure.

According to another embodiment of the present disclosure, a computer program product or a computer program is provided. The computer program product or computer program includes computer instructions stored in a computer-readable storage medium. A processor of the computer device reads the computer instructions from the computer readable storage medium, and the processor executes the computer instructions, so that the computer device executes the methods provided in the various optional implementations described in the embodiments of present disclosure.

In the embodiment of present disclosure, a live broadcast method is provided, the live broadcast method includes: obtaining a volumetric video, and the volumetric video is configured to display a live broadcast behavior of a 3D live object; obtaining a 3D virtual scene, and the 3D virtual scene is configured to display a 3D scene content; combining the volumetric video and the 3D virtual scene to obtain a 3D live broadcast content including the live broadcast behavior and the 3D scene content; and generating a 3D live broadcast screen based on the 3D live broadcast content, and the 3D live broadcast screen is configured to play on a live broadcast platform.

In this way, by obtaining a live behavior volumetric video configured to show a 3D live object. Since the volumetric video directly and excellently expresses the live broadcast behavior in the form of a 3D dynamic model sequence, the volumetric video can be directly and conveniently combined with the 3D virtual scene to obtain the 3D live broadcast content as the 3D content source. The 3D content source can express the live content including live broadcast behavior and 3D scene content extremely well. The generated 3D live broadcast content such as action behavior and other live broadcast content is highly natural and can display the live broadcast content from multiple angles, thereby effectively improving the virtual live broadcast effect.

### DESCRIPTION OF DRAWINGS

In order to illustrate the technical solutions in the embodiments of the present disclosure more clearly, the following briefly introduces the accompanying drawings that are used in the description of the embodiments. Obviously, drawings in the following description are only some embodiments of the present disclosure. For those skilled in the art, other drawings can also be obtained from these drawings without creative effort.

FIG. 1 is a schematic diagram of a system to that can be applied to an embodiment of the present disclosure.

FIG. 2 is a flowchart of a live broadcast method according to an embodiment of the present disclosure.

FIG. 3 is a flow chart of live broadcast of a virtual concert according to an embodiment of the present disclosure in a scene.

FIG. 4 is a schematic diagram of a live broadcast client interface of a live broadcast client.

FIG. 5 is a schematic diagram of a 3D live broadcast screen played on a live broadcast room interface.

FIG. 6 is a schematic diagram of a 3D live broadcast screen played on the live broadcast room interface.

FIG. 7 is another schematic diagram of the 3D live broadcast screen played on the live broadcast room interface.

FIG. 8 is yet another schematic diagram of the 3D live broadcast screen played on the live broadcast room interface.

FIG. 9 is still another schematic diagram of the 3D live broadcast screen played on the live broadcast room interface.

FIG. 10 is still another schematic diagram of the 3D live broadcast screen played on the live broadcast room interface.

FIG. 11 is still another schematic diagram of the 3D live broadcast screen played on the live broadcast room interface.

FIG. 12 is still another schematic diagram of the 3D live broadcast screen played on the live broadcast room interface.

FIG. 13 is still another schematic diagram of the 3D live broadcast screen played on the live broadcast room interface.

FIG. 14 is still another schematic diagram of the 3D live broadcast screen played on the live broadcast room interface.

FIG. 15 is still another schematic diagram of the 3D live broadcast screen played on the live broadcast room interface.

FIG. 16 is still another schematic diagram of the 3D live broadcast screen played on the live broadcast room interface.

FIG. 17 is still another schematic diagram of the 3D live broadcast screen played on the live broadcast room interface.

FIG. 18 is a block diagram of a live broadcast device according to an embodiment of the present disclosure.

FIG. 19 is a block diagram of an electronic device according to an embodiment of the present disclosure.

### DETAILED DESCRIPTION OF PREFERRED EMBODIMENTS

The technical solutions in the embodiments of the present disclosure will be clearly and completely described below with reference to the accompanying drawings in the embodiments of the present disclosure. Obviously, the described embodiments are only a part of the embodiments of the present disclosure, but not all of the embodiments. Based on the embodiments in the present disclosure, all other embodiments obtained by those skilled in the art without creative work fall within the protection scope of the present disclosure.

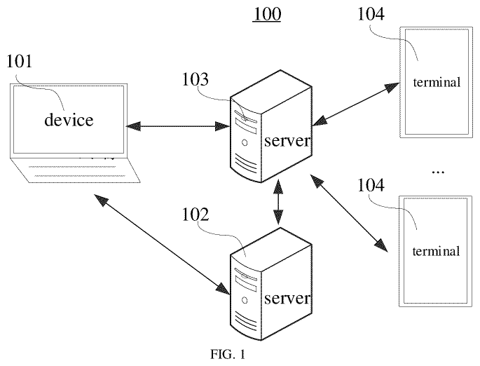

FIG. 1 is a schematic diagram of a system to that can be applied to an embodiment of the present disclosure. Refer to FIG. 1, a system 100 may include a device 101, a server 102, a server 103 and a terminal 104.

The device 101 may be a server or a computer and other devices with a data processing function.

The server 102 and the server 103 may be independent physical servers, or may be a server cluster or distributed system composed of multiple physical servers, or may be cloud servers that provide basic cloud computing services such as cloud services, cloud databases, cloud databases, cloud computing, cloud function, cloud storage, network service, cloud communication, middleware service, domain name service, security service, CDN (Content Delivery Network), and big data and artificial intelligence platform.

Terminal 104 may be any terminal device. The terminals 104 include but are not limited to mobile phones, computers, intelligent voice interaction devices, smart home appliances, vehicle-mounted terminals, VR (Virtual Reality)/AR (Augmented Reality) devices, smart watches, computers, and the like.

In one embodiment of this example, the device 101 is a computer of a content provider. The server 103 is the platform server of the live broadcast platform. The terminal 104 is a terminal on which a live broadcast client is installed. The server 102 is an information relay server connecting the device 101 and the server 103, wherein the device 101 and the server 103 can also be directly communicated and connected through a preset interface.

Wherein, the device 101 can: obtain a volumetric video, and the volumetric video is configured to display a live broadcast behavior of a 3D live object; obtain a 3D virtual scene, and the 3D virtual scene is configured to display a 3D scene content; combine the volumetric video and the 3D virtual scene to obtain a 3D live broadcast content including the live broadcast behavior and the 3D scene content; and generate a 3D live broadcast screen based on the 3D live broadcast content, and the 3D live broadcast screen is configured to play on a live broadcast platform.

The 3D live broadcast screen may be transmitted by the device 101 to the server 103 through a preset interface, or the device 101 may be transferred to the server 103 through the server 102. Furthermore, the server 103 may transmit the 3D live broadcast screen to the live broadcast client in the terminal 104.

Furthermore, the terminal 104 may: in response to a live room opening operation, displaying a live broadcast room interface, and playing a 3D live broadcast screen in the live broadcast room interface, and the 3D live broadcast screen is generated according to the live broadcast method described in any one of the foregoing embodiments.

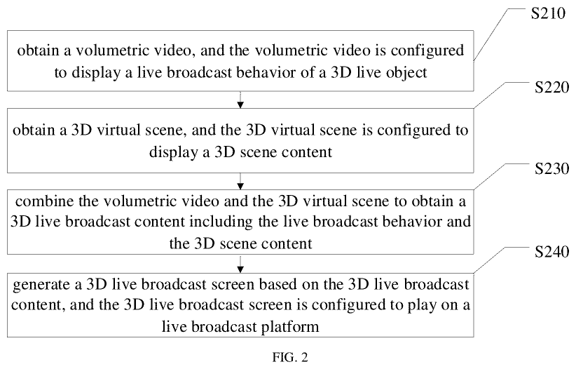

A flowchart of the live broadcast method according to one embodiment of the present disclosure is schematically shown in FIG. 2. The execution subject of the live broadcast method may be any device, such as a server or a terminal. In one manner, the execution subject is the device 101 shown in FIG. 1.

As shown in FIG. 2, the live broadcast method may include steps S210 to S240.

Step S210, obtain a volumetric video, and the volumetric video is configured to display a live broadcast behavior of a 3D live object.

Step S220, obtain a 3D virtual scene, and the 3D virtual scene is configured to display a 3D scene content.

Step S230, combine the volumetric video and the 3D virtual scene to obtain a 3D live broadcast content including the live broadcast behavior and the 3D scene content.

Step S240, generate a 3D live broadcast screen based on the 3D live broadcast content, and the 3D live broadcast screen is configured to play on a live broadcast platform.

Volumetric video is a 3D dynamic model sequence used to show the live behavior of 3D live objects. The volumetric video may be obtained from a predetermined location, for example, the device obtains the volumetric video from local memory or other devices. A 3D live broadcast object is a 3D virtual object corresponding to a real live broadcast object (such as a human, an animal, or a machine, etc.). The live broadcast behavior is, for example, an act of dancing. Preliminarily shoot for a real live broadcast object performing a live broadcast to collect data such as color information, material information, depth information, etc. Based on a conventional volumetric video generation algorithm, a volumetric video for showing the live behavior of a 3D live object can be generated.

The 3D virtual scene is used to display the content of the 3D scene. The 3D scene content may include a 3D virtual scene (eg, a scene such as a stage) and virtual interactive content (eg, 3D special effects). The 3D virtual scene can be obtained from a predetermined location, such as a device, from local memory or from other devices. In advance, a 3D virtual scene can be created through a 3D software or program.

By directly combining volumetric video and the 3D virtual scene in a virtual engine (such as UE4, UE5, Unity 3D, etc.), 3D live broadcast content including live broadcast behavior and 3D scene content can be obtained. Based on the 3D live broadcast content, a video screen from any viewing angle in the 3D space can be continuously recorded, thereby generating a 3D live broadcast screen composed of continuous video screens with continuously switched viewing angles. The 3D live broadcast screen can be placed on the live broadcast platform for play in real time, thereby realizing a 3D virtual live broadcast.

In this way, based on steps S210 to S240, by obtaining a live behavior volumetric video for showing a 3D live object. Since the volumetric video directly and excellently expresses the live broadcast behavior in the form of a 3D dynamic model sequence, the volumetric video can be directly and conveniently combined with the 3D virtual scene to obtain the 3D live broadcast content as the 3D content source. The 3D content source can extremely well represent the live content including the live behavior and the 3D scene content. In the generated 3D live broadcast screen, the live broadcast content such as an action behavior is highly natural, and the live broadcast content can be displayed from multiple angles, and further, the virtual live broadcast effect can be effectively improved.

Further optional other embodiments of the steps performed during live broadcast in the embodiment of FIG. 2 are described below.

In one embodiment, in step S240, the step of generating the 3D live broadcast screen based on the 3D live broadcast content includes: playing the 3D live broadcast content; and transforming according to a target angle in a 3D space, and recording a video screen of a played 3D live broadcast content to obtain the 3D live broadcast screen.

The 3D live broadcast content is played on the device, and the 3D live broadcast content can dynamically display the live broadcast behavior of the 3D live broadcast object and the 3D scene content. By transforming the virtual camera according to the target angle in the 3D space, the 3D live broadcast content can be continuously recorded as a video screen, and the 3D live broadcast screen can be obtained.

In one embodiment, a virtual camera track is disposed on the 3D live broadcast content. The step of transforming according to the target angle in the 3D space, and recording the video screen of the played 3D live broadcast content to obtain the 3D live broadcast screen includes: transforming a recording angle in the 3D space following the virtual camera track, and recording the video screen of the 3D live broadcast content to obtain the 3D live broadcast screen.

After the 3D live broadcast content is produced, a virtual camera track is built in the 3D live broadcast content. By moving the virtual camera along the virtual camera track, the recording angle can be transformed in 3D space. The video screen of the 3D live broadcast content is recorded to obtain a 3D live broadcast screen, so that users can watch the live broadcast from multiple angles of the virtual camera track.

In one embodiment, the step of transforming according to the target angle in the 3D space, and recording the video screen of the played 3D live broadcast content to obtain the 3D live broadcast screen includes: transforming a recording angle in the 3D space following a gyroscope in the device, and recording the video screen of the 3D live broadcast content to obtain the 3D live broadcast screen. It can realize 360-degree viewing of live broadcast based on gyroscope.

In one embodiment, the step of transforming according to the target angle in the 3D space, and recording the video screen of the played 3D live broadcast content to obtain the 3D live broadcast screen includes: transforming a recording angle in the 3D space according to a change operation of a viewing angle sent by a live client in the live platform; and recording the video screen of the played 3D live broadcast content to obtain the 3D live broadcast screen.

When watching the live broadcast in the live broadcast room, a user can change the viewing angle by rotating the viewing device or moving the viewing angle on the screen. According to the changing operation of the viewing angle, the equipment outside the live broadcast platform changes the recording angle in 3D space. By recording a video screen of the 3D live broadcast content, the 3D live broadcast screens corresponding to different users can be obtained.

In one embodiment, the 3D live broadcast content includes a predetermined 3D content and at least one virtual interactive content; the step of playing the 3D live broadcast content includes:

Playing the predetermined 3D content in the 3D live broadcast content; and in response to detecting an interaction trigger signal in the live broadcast platform, playing the virtual interaction content corresponding to the interaction trigger signal relative to the predetermined 3D content.

The predetermined 3D content can be a predetermined portion of the regularly played content. The predetermined 3D content can include some or all in volumetric video, as well as some 3D scenes in the 3D virtual scene. In the device in FIG. 1 as an example, the predetermined 3D content is played and video is recorded, and the 3D live broadcast screen is generated and placed in the live broadcast room of the live broadcast platform. Users can watch the initial 3D live broadcast screen corresponding to the predetermined 3D content through the terminal 104 in FIG. 1 as an example. It is understood that due to the transformation of the recording angle, the continuous video screen in the initial 3D live broadcast may show all or part of the predetermined 3D content, and it is displayed from different angles in the 3D space.

The 3D virtual scene further includes at least one kind of virtual interactive content, and the at least one kind of virtual interactive content is played when triggered. In the live broadcast room of the live broadcast client, the user can trigger an “interaction trigger signal” by triggering an operation (such as sending a gift, etc.) through relevant interactive content. When an interaction trigger signal in the live broadcast platform is detected in the device taking the device 101 in FIG. 1 as an example, the virtual interaction content corresponding to the interaction trigger signal is determined from at least one kind of virtual interaction content. Then, relative to the predetermined 3D content, the virtual interactive content corresponding to the interactive trigger signal is played at a predetermined position. Wherein, different interaction trigger signals correspond to different virtual interactive contents, and the virtual interactive contents may be 3D special effects, for example, special effects such as 3D fireworks, 3D barrage, or 3D gifts.

Accordingly, the played 3D live broadcast content may at least include predetermined 3D content and virtual interactive content. Record a video screen of the 3D live broadcast content to be played, and generate a 3D live broadcast screen and put it on the live broadcast platform. The user can watch the interactive 3D live broadcast screen corresponding to the predetermined 3D content and the virtual interactive content in the live broadcast room. It can be understood that, due to the change of the recording angle, all or part of the predetermined 3D content and the virtual interactive content may be displayed in the continuous video screen s in the interactive 3D live broadcast, and displayed from different angles in the 3D space.

Wherein, the production method of the virtual interactive content may be the production method of traditional CG special effects. For example, special effects maps can be made using plane software, special effects sequence diagrams can be made using special effect software (such as AE, CB, PI, etc.), and characteristic models can be made using 3D software (such as 3DMAX, MAYA, XSI, LW, etc.), and realize the required special effects visual effects through program code in the game engine.

In this way, deep 3D virtual deep interactive live broadcast can be realized through user interaction, which further improves the virtual live broadcast experience.

In one embodiment, the 3D live broadcast content includes a predetermined 3D content; the 3D live broadcast screen is played in the live broadcast room on the live broadcast platform; the step of playing the 3D live broadcast content includes:

Playing the predetermined 3D content in the 3D live broadcast content; and in response to detecting that a user has joined the live broadcast room, displaying an avatar of the user at a predetermined position relative to the predetermined 3D content.

The predetermined 3D content can be a predetermined portion of the regularly played content. The predetermined 3D content can include some or all in volumetric video, as well as some 3D scenes in the 3D virtual scene. In the device in FIG. 1 as an example, the predetermined 3D content is played and video is recorded, and the 3D live broadcast screen is generated and placed in the live broadcast platform. The user can view the initial 3D live broadcast screen corresponding to the predetermined 3D content on the live broadcast room live broadcast room interface in the terminal 104 in FIG. 1 as an example.

After the user enters the live broadcast room, in the device, taking the device 101 in FIG. 1 as an example, a user-specific avatar is displayed at a predetermined position relative to the predetermined 3D content. The 3D virtual scene forms part of the 3D live broadcast content, further enhancing the virtual live broadcast experience. Based on this, the 3D live broadcast content of the broadcast can include at least 3D content and the virtual scene of users. In the device in FIG. 1 as an example, the video screen is recorded for the 3D live broadcast content of the broadcast, and the 3D live broadcast screen is generated to the live broadcast platform. The user can watch the predetermined 3D content and the subsequent 3D live broadcast screen corresponding to the user's avatar on the live broadcast room live broadcast room interface in the terminal taking the terminal 104 in FIG. 1 as an example. It can be understood that due to the change of the recording angle, in the subsequent continuous video screens in the 3D live broadcast screen, all or part of the predetermined 3D content and the user's avatar in the live broadcast room may be displayed, and displayed from different angles in the 3D space.

Furthermore, in some embodiments, taking the device 101 in FIG. 1 as an example, the user's interactive information in the live broadcast room (such as giving gifts or likes or communication information in the communication area, etc.) can be obtained through the interface provided by the live broadcast platform. The interactive type of interactive information can be classified to obtain the user's interactive type, and different interactive types correspond to different points. In the end, all users in the live broadcast room will be ranked after their points are counted, and the top users with predetermined names will get special avatars (such as avatars with golden glittering effects).

Furthermore, in some embodiments, after the user enters the live broadcast room, the device in FIG. 1 as an example can collect user's identification information such as user ID or name, and display the identification information at a predetermined position relative to the avatar. For example, a user ID corresponding to an exclusive avatar is generated to be placed on the top of the avatar's head.

In one embodiment, after the step of playing the predetermined 3D content in the 3D live broadcast content, the live broadcast method further includes: in response to detecting a content adjustment signal in the live broadcast platform, adjusting and playing the predetermined 3D content.

In the terminal taking the terminal 104 in FIG. 1 as an example, the user can trigger the content adjustment signal through the relevant interactive content trigger operation (such as an operation such as sending a gift) in the live broadcast client. Taking the device 101 in FIG. 1 as an example, when a content adjustment signal in the live broadcast platform is detected, the predetermined 3D content is adjusted and played. For example, the virtual 3D live broadcast object or the signal in the virtual live broadcast scene content can be dynamically adjusted to the corresponding content, such as zooming in, zooming out, or changing from time to time, so as to further improve the virtual live broadcast experience.

Accordingly, the 3D content to be played includes the predetermined 3D content that is adjusted to be played. Taking the device 101 in FIG. 1 as an example, a video screen is recorded for the 3D content being played, and a 3D live broadcast screen is generated and placed on the live broadcast platform. In the terminal taking the terminal 104 in FIG. 1 as an example, the user can view the transformed 3D live broadcast screen corresponding to the predetermined 3D content adjusted and played on the live broadcast room live broadcast room interface. It can be understood that, due to the change of the recording angle, all or part of the predetermined 3D content adjusted and played may be displayed in the continuous video screen in the transformed 3D live broadcast screen, and displayed from different angles in the 3D space.

In one embodiment, the predetermined 3D content includes a virtual 3D live broadcast object in the volumetric video. The content adjustment signal includes an object adjustment signa. The step of in response to detecting the content adjustment signal in the live broadcast platform, adjusting and playing the predetermined 3D content includes: in response to detecting the object adjustment signal in the live broadcast platform, dynamically adjusting the virtual 3D live broadcast object. Taking the device 101 in FIG. 1 as an example, if an object adjustment signal is detected, the virtual live broadcast object will be played for dynamic adjustment and playback (play after zooming in, play after zooming out, play with big and small changes, or play with particle effects, etc.), and a video screen is recorded. Furthermore, in the continuous video screen in the transformed 3D live broadcast screen in the live broadcast room, if a virtual live broadcast object is recorded, the virtual live broadcast object adjusted and played can be seen, which further improves the virtual live broadcast experience.

In one embodiment, the 3D live broadcast screen is played in the live broadcast room on the live broadcast platform. After the step of playing the predetermined 3D content in the 3D live broadcast content, the live broadcast method further includes: obtaining interaction information in the live broadcast room; and classifying the interaction information to obtain an event trigger signal in the live broadcast platform, and the event trigger signal includes at least one of an interaction trigger signal and a content adjustment signal.

The interactive information in the live broadcast room is, for example, the sending of gifts or likes or the communication information in the communication area generated by the related interactive content triggering operation in the live broadcast client. The content interaction information in the live broadcast room is usually diverse. By classifying the interactive information and determining the corresponding event trigger signal, the corresponding virtual interactive content or the adjustment and playback of the predetermined 3D content can be accurately triggered. For example, by classifying the interaction information, it can be determined that the event trigger signal corresponding to the interaction information is the interaction trigger signal for sending fireworks gifts and the content adjustment signal for predetermined 3D content, so that, it is possible to play 3D fireworks special effects (virtual interactive content), and/or adjust and play predetermined 3D content. Among them, by building a relay information server, based on the relay information server, interactive information can be obtained from the interface provided by the live broadcast platform. It can be understood that, according to different interaction trigger timings, the 3D live broadcast screen played on the live broadcast room interface can be an initial 3D live broadcast screen, an interactive 3D live broadcast screen, a subsequent 3D live broadcast screen, a transformed 3D live broadcast screen, or a multi-type interactive 3D live broadcast screen. The multi-type interactive 3D live broadcast screen may be obtained by recording video screens of at least three of the predetermined 3D live broadcast content, virtual interactive content, adding the user's avatar in the live broadcast room, and adjusting and playing the predetermined 3D content. Accordingly, the 3D live broadcast content to be played may include at least three types of predetermined 3D live broadcast content, virtual interactive content, adding a user's avatar in the live broadcast room, and adjusting and playing the predetermined 3D content. The video screen is recorded for the 3D live broadcast content to be played, and the 3D live broadcast screen is generated and placed on the live broadcast platform. Users can watch multiple types of interactive 3D live broadcast screens in the live broadcast room. It can be understood that due to the change of the recording angle, all or part of the played 3D live broadcast content may be displayed in the continuous video screen in the multi-type interactive 3D live broadcast screen, and displayed from different angles in the 3D space.

Furthermore, in some embodiments, after the live broadcast of the 3D live broadcast content in the live broadcast room ends, the content direction may be determined by voting in the live broadcast room. For example, after the live broadcast, the next or previous live broadcast or replay can be decided by voting.

In one embodiment, the step S230, combining the volumetric video and the 3D virtual scene to obtain the 3D live broadcast content including the live broadcast behavior and the 3D scene content includes:

Adjusting the volumetric video and the 3D virtual scene according to the combined adjustment operation of the volumetric video and the 3D virtual scene; and in response to a combination confirmation operation, combining the volumetric video with the 3D virtual scene to obtain at least one 3D live broadcast content including the live broadcast behavior and the 3D scene content.

The volumetric video can be put into a virtual engine through a plug-in, and the 3D virtual scene can also be directly placed in the virtual engine. Relevant users can perform combined adjustment operations for the volumetric video and 3D virtual scene in the virtual engine, such as position adjustment, size adjustment, rotation adjustment, and rendering operations. After the adjustment is completed, the relevant user triggers the combination confirmation operation, and the adjusted volumetric video and the 3D virtual scene are combined into a whole in the device to obtain at least one 3D live broadcast content.

In one embodiment, the step S230, combining the volumetric video and the 3D virtual scene to obtain the 3D live broadcast content including the live broadcast behavior and the 3D scene content includes:

Obtaining a volumetric video description parameter of the volumetric video; obtaining a virtual scene description parameter of the 3D virtual scene; jointly analyzing the volumetric video description parameter and the virtual scene description parameter to obtain at least one content combination parameter; and combining the volumetric video and the 3D virtual scene according to the content combination parameter to obtain at least one 3D live broadcast content including the live broadcast behavior and the 3D scene content.

The volumetric video description parameter is a related parameter that can describe volumetric video. The volumetric video description parameters may include object information (such as gender, name, etc.) of the 3D live broadcast object in the volumetric video, and live broadcast behavior information (such as dancing, martial arts, eating, etc.). The virtual scene description parameter is a related parameter that can describe the content of the 3D scene in the 3D virtual scene. The virtual scene description parameters may include item information of scene items included in the 3D scene content (for example, item name and item color, etc.), and relative positional relationship information between scene items.

The content combination parameter is a parameter for combining the volumetric video and the 3D virtual scene. The content combination parameters may include the volume size corresponding to the volumetric video in the 3D space, the placement position of the scene items relative to the 3D virtual scene, and the item volume size of the scene items in the 3D virtual scene. Different content combination parameters have different parameters.

The volumetric video and the 3D virtual scene are combined according to each content combination parameter to obtain a 3D live broadcast content respectively.

In an embodiment, there is one content combination parameter, which can be combined to obtain a 3D live broadcast content. In another embodiment, there are at least two content combination parameters, and the volumetric video and the 3D virtual scene are respectively combined based on the at least two content combination parameters to obtain at least two 3D live broadcast contents. In this way, corresponding 3D live broadcast screens can be further generated based on different 3D live broadcast contents. The 3D live broadcast screens generated by each 3D live broadcast content can be played in different live broadcast rooms respectively, and users can select a live broadcast room to watch, which further improves the live broadcast effect.

In one embodiment, the step of jointly analyzing the volumetric video description parameter and the virtual scene description parameter to obtain at least one content combination parameter includes: jointly analyzing the volumetric video description parameter and the virtual scene description parameter to obtain at least one content combination parameter.

Wherein, the joint analysis method: in one way, the preset combination parameters corresponding to both the volumetric video description parameter and the virtual scene description parameter can be queried in the preset combination parameter table to obtain at least one content combination parameter. In another way, the volumetric video description parameters and virtual scene description parameters can be input into a pre-trained first analysis model based on machine learning, and the first analysis model performs joint analysis on it and outputs at least one combination of information and the confidence level of each combination of information. Each type of combination information corresponds to a content combination parameter.

In one embodiment, the step of jointly analyzing the volumetric video description parameter and the virtual scene description parameter to obtain at least one content combination parameter includes:

Obtaining a terminal parameter of a terminal used by a user in the live broadcast platform and a user description parameter of the user; and jointly analyzing the volumetric video description parameter, the virtual scene description parameter, the terminal parameter, and the user description parameter to obtain at least one content combination parameter.

The terminal parameters are parameters related to the terminal, and the terminal parameters may include parameters such as terminal model and terminal type. The user description parameters are parameters related to the user, and the user description parameter may include parameters such as gender and age. Terminal parameters and user description parameters can be legally obtained with the user's permission/authorization.

Wherein, the joint analysis method: in one way, preset combination parameters corresponding to volumetric video description parameters, virtual scene description parameters, terminal parameters, and user description parameters can be queried in the preset combination parameter table to obtain at least one content combination parameter. In another way, the volumetric video description parameters, virtual scene description parameters, terminal parameters and user description parameters can be input into a pre-trained second analysis model based on machine learning, and the second analysis model performs joint analysis on it, and outputs at least one combination of information and the confidence level of each combination of information. Each type of combination information corresponds to a content combination parameter.

In one embodiment, there is at least one 3D live broadcast content, and different 3D live broadcast contents are used to generate 3D live broadcast screens recommended to users of different categories. For example, three different representations of 3D live content are generated in combination. The live broadcast room where the first 3D live broadcast screen generated by the first 3D live broadcast content is placed is recommended to category A users, and the live broadcast room where the 3D live broadcast screen generated by the second 3D live broadcast content is recommended to category B users.

In one embodiment, there is at least one 3D live broadcast content, and different 3D live broadcast contents are used to generate 3D live broadcast screens to be delivered to different live broadcast rooms. Different live broadcast rooms can be recommended to all users, and users can choose a live broadcast room to watch the 3D live broadcast screen of the corresponding live broadcast room.

A live broadcast method according to another embodiment of the present disclosure. The execution subject of the live broadcast method may be any device with a display function, such as the terminal 104 shown in FIG. 1.

A live broadcast method, including: in response to a live room opening operation, displaying a live broadcast room interface, and playing a 3D live broadcast screen in the live broadcast room interface, and the 3D live broadcast screen is generated according to the live broadcast method described in any one of the foregoing embodiments.

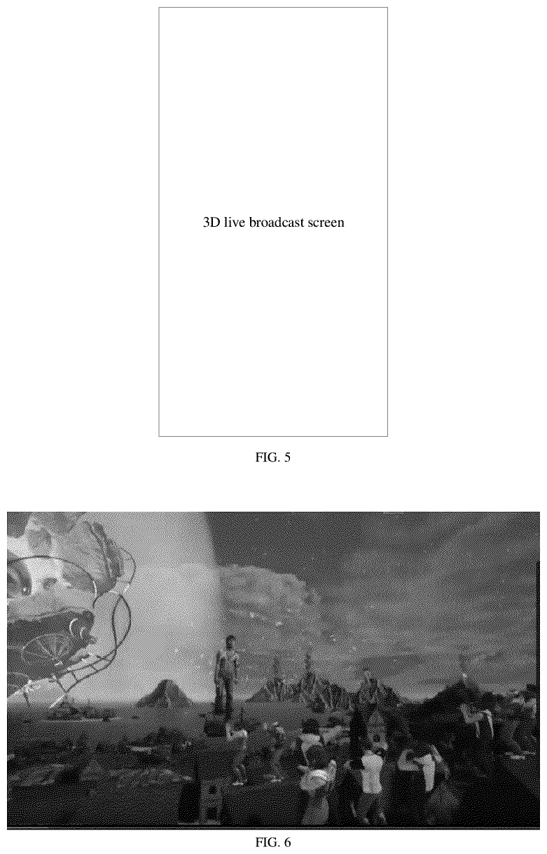

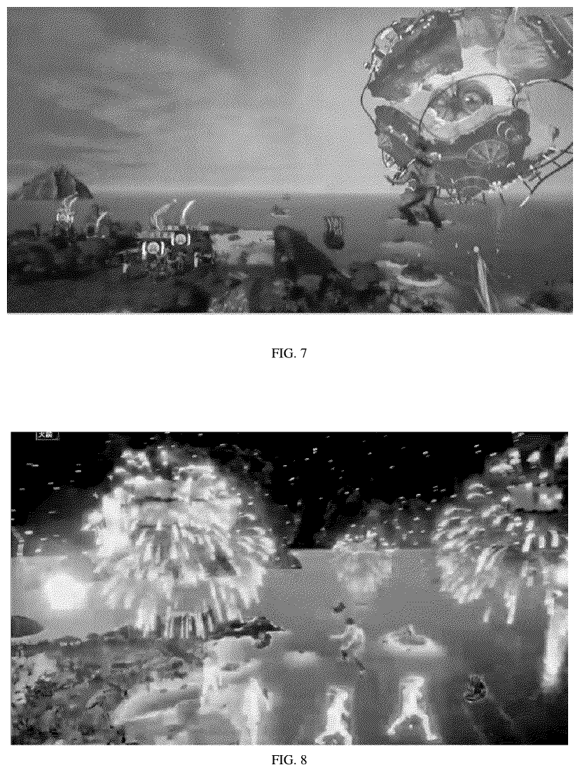

In the terminal taking the terminal 104 in FIG. 1 as an example, the user may perform an operation of opening a live broadcast room in a live broadcast client (eg, a live broadcast disclosure of a certain platform). Live room opening operations such as voice control or screen touch. In response to the live room opening operation, the live broadcast client displays the live broadcast room interface, and the 3D live broadcast screen can be played in the live broadcast room interface for the user to watch. Referring to FIG. 5 and FIG. 6, two frames in the continuous video screen of the 3D live broadcast screen are shown in FIGS. 6 and 7, which are obtained by recording the played 3D live broadcast content from different angles.

In one embodiment, the step of in response to the live room opening operation, displaying the live broadcast room interface includes: displaying a live broadcast client interface, and displaying at least one live broadcast room in the live broadcast client interface; and in response to the live room opening operation for a target live broadcast room in the at least one live broadcast room, displaying the live broadcast room interface of the target live broadcast room.

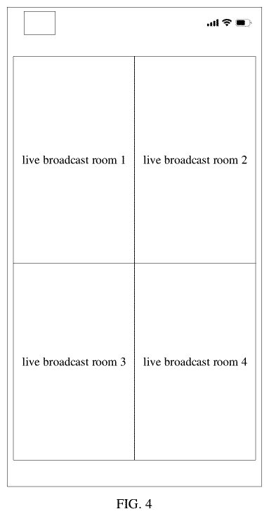

The live broadcast client interface is the interface of the live broadcast client. In the terminal taking the terminal 104 in FIG. 1 as an example, the user can open the live broadcast client in the terminal through voice control or screen touch, so as to display the live broadcast client interface in the terminal. At least one live broadcast room is displayed in the live broadcast client interface, and further, the user can select a target live broadcast room to perform a live broadcast room opening operation, so as to display the live broadcast room interface of the target live broadcast room. For example, referring to FIGS. 4 and 5, in a scenario, the displayed live broadcast client interface is shown in FIG. 4, and the live broadcast client interface displays at least 4 live broadcast rooms. After the user selects a target live broadcast room to open, the displayed live broadcast room interface of the target live broadcast room is shown in FIG. 5.

Furthermore, in one embodiment, the step of displaying a live broadcast client interface, and displaying at least one live broadcast room on the live broadcast client interface, includes: displaying at least one live broadcast room, and each live broadcast room is configured to play 3D live broadcast screens corresponding to different 3D live broadcast contents, and each of the live broadcast rooms can display relevant content corresponding to the 3D live broadcast content (As shown in FIG. 4, each of the live broadcast rooms can display relevant content corresponding to the 3D live broadcast content when it is not opened by the user). The user can select a target live broadcast room in at least one live broadcast room to open according to the relevant content.

In one embodiment, the step of in response to the live room opening operation, displaying the live broadcast room interface, and playing the 3D live broadcast screen in the live broadcast room interface includes: in response to the live room opening operation, displaying the live broadcast room interface, and displaying an initial 3D live broadcast screen in the live broadcast room interface, and the initial 3D live broadcast screen is obtained by recording a video screen of the predetermined 3D content played in the 3D live broadcast content; and in response to an interactive content triggering operation on the live broadcast room interface, displaying an interactive 3D live broadcast screen in the live broadcast room interface, and the interactive 3D live broadcast screen is obtained by recording a video screen of a played predetermined 3D content and a virtual interactive content triggered by the interactive content triggering operation, and the virtual interactive content belongs to the 3D live broadcast content.

The predetermined 3D content can be a predetermined portion of the regularly played content. The predetermined 3D content can include some or all in volumetric video, as well as some 3D scenes in the 3D virtual scene. In the device taking the device 101 in FIG. 1 as an example, the predetermined 3D content is played and the video screen is recorded, and the 3D live broadcast screen is generated and placed in the live broadcast room of the live broadcast platform. In the terminal taking the terminal 104 in FIG. 1 as an example, the user can watch the initial 3D live broadcast screen corresponding to the predetermined 3D content through the live broadcast room interface corresponding to the live broadcast room. It can be understood that, due to the change of the recording angle, all or part of the predetermined 3D content may be displayed in the continuous video screen in the initial 3D live broadcast screen, and displayed from different angles in the 3D space.

The 3D virtual scene further includes at least one kind of virtual interactive content, and the at least one kind of virtual interactive content is played when triggered. In the live broadcast room of the live broadcast client, the user can trigger an “interaction trigger signal” by triggering an operation (such as sending a gift, etc.) through relevant interactive content. When an interaction trigger signal in the live broadcast platform is detected in the device taking the device 101 in FIG. 1 as an example, the virtual interaction content corresponding to the interaction trigger signal is determined from at least one type of virtual interaction content. Then, the virtual interactive content corresponding to the interactive trigger signal may be played at a predetermined position relative to the predetermined 3D content. Wherein, different interaction trigger signals may correspond to different virtual interactive contents, and the virtual interactive contents may be 3D special effects, for example, special effects such as 3D fireworks, 3D barrage, or 3D gifts.

Accordingly, the played 3D live broadcast content may at least include predetermined 3D content and virtual interactive content. Record a video screen of the 3D live broadcast content to be played, and generate a 3D live broadcast screen and put it on the live broadcast platform. The user can watch the interactive 3D live broadcast screen corresponding to the predetermined 3D content and the virtual interactive content in the live broadcast room. It can be understood that, due to the change of the recording angle, all or part of the predetermined 3D content and the virtual interactive content may be displayed in the continuous video screen s in the interactive 3D live broadcast, and displayed from different angles in the 3D space. Referring to FIG. 8, 3D fireworks are displayed in one frame of video screen in the interactive 3D live broadcast screen shown in FIG. 8.

In one embodiment, after the step of in response to the live room opening operation, displaying the live broadcast room interface, and displaying an initial 3D live broadcast screen in the live broadcast room interface, the live broadcast method further includes:

In response to a user joining the live broadcast room corresponding to the live broadcast room interface, displaying a subsequent 3D live broadcast screen in the live broadcast room interface, and the subsequent 3D live broadcast screen is obtained by recording a video screen of the played predetermined 3D content and an avatar of the user who joined the live broadcast room.

The predetermined 3D content can be a predetermined portion of the regularly played content. The predetermined 3D content can include some or all in volumetric video, as well as some 3D scenes in the 3D virtual scene. In the device in FIG. 1 as an example, the predetermined 3D content is played and video is recorded, and the 3D live broadcast screen is generated and placed in the live broadcast platform. The user can view the initial 3D live broadcast screen corresponding to the predetermined 3D content on the live broadcast room live broadcast room interface in the terminal 104 in FIG. 1 as an example.

After the user enters the live broadcast room, in the device, taking the device 101 in FIG. 1 as an example, a user-specific avatar is displayed at a predetermined position relative to the predetermined 3D content. The 3D virtual scene forms part of the 3D live broadcast content, further enhancing the virtual live broadcast experience. Based on this, the 3D live broadcast content of the broadcast can include at least 3D content and the virtual scene of users. In the device in FIG. 1 as an example, the video screen is recorded for the 3D live broadcast content of the broadcast, and the 3D live broadcast screen is generated to the live broadcast platform. The user can watch the predetermined 3D content and the subsequent 3D live broadcast screen corresponding to the user's avatar on the live broadcast room live broadcast room interface in the terminal taking the terminal 104 in FIG. 1 as an example. It can be understood that due to the change of the recording angle, in the subsequent continuous video screens in the 3D live broadcast screen, all or part of the predetermined 3D content and the user's avatar in the live broadcast room may be displayed, and displayed from different angles in the 3D space.

Further, in some embodiments, taking the device 101 in FIG. 1 as an example, the user's interactive information in the live broadcast room (such as giving gifts or likes or communication information in the communication area, etc.) can be obtained through the interface provided by the live broadcast platform. The interactive type of interactive information can be classified to obtain the user's interactive type, and different interactive types correspond to different points. In the end, all users in the live broadcast room will be ranked after their points are counted, and the top users with predetermined names will get special avatars (such as avatars with golden glittering effects).

Furthermore, in some embodiments, after the user enters the live broadcast room, the device in FIG. 1 as an example can collect user's identification information such as user ID or name, and display the identification information at a predetermined position relative to the avatar. For example, a user ID corresponding to an exclusive avatar is generated to be placed on the top of the avatar's head.

Furthermore, in one embodiment, after the step of in response to the live room opening operation, displaying the live broadcast room interface, and displaying an initial 3D live broadcast screen in the live broadcast room interface, the live broadcast method further includes:

In response to the interactive content triggering operation on the live broadcast room interface, displaying a transformed 3D live broadcast screen in the live broadcast room interface, and the transformed 3D live broadcast screen is obtained by recording a video screen of the predetermined 3D content adjusted and played, and an adjustment and playing of the 3D content is triggered by the interactive content triggering operation.

In the terminal taking the terminal 104 in FIG. 1 as an example, the user can trigger the content adjustment signal through a relevant interactive content triggering operation (eg, an operation such as sending a gift or a gesture operation, etc.) in the live broadcast client. Taking the device 101 in FIG. 1 as an example, when a content adjustment signal in the live broadcast platform is detected, the predetermined 3D content is adjusted and played. For example, the virtual 3D live broadcast object or the signal in the virtual live broadcast scene content can be dynamically adjusted to the corresponding content, such as zooming in, zooming out, or changing from time to time, so as to further improve the virtual live broadcast experience.

Accordingly, the 3D content to be played includes the predetermined 3D content that is adjusted to be played. Taking the device 101 in FIG. 1 as an example, a video screen is recorded for the 3D content being played, and a 3D live broadcast screen is generated and placed on the live broadcast platform. In the terminal taking the terminal 104 in FIG. 1 as an example, the user can view the transformed 3D live broadcast screen corresponding to the predetermined 3D content adjusted and played on the live broadcast room live broadcast room interface. It can be understood that, due to the change of the recording angle, all or part of the predetermined 3D content adjusted and played may be displayed in the continuous video screen in the transformed 3D live broadcast screen, and displayed from different angles in the 3D space.

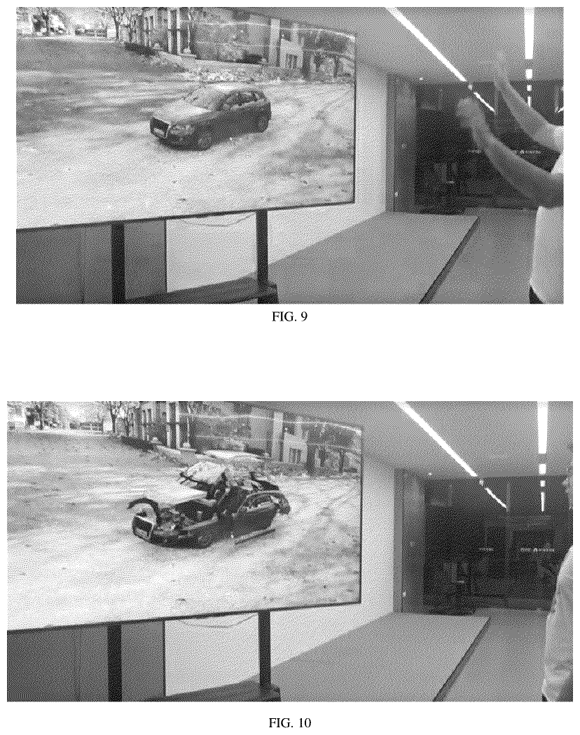

In one embodiment, the predetermined 3D content includes the virtual 3D live broadcast object in the volumetric video; and the content adjustment signal includes an object adjustment signal. When the object adjustment signal in the live broadcast platform is detected in the device taking the device 101 in FIG. 1 as an example, the virtual 3D live broadcast object is dynamically adjusted (for example, make dynamic adjustments, such as zooming in and playing, zooming out and playing, playing with big and small changes, playing with special effects of particles, or playing by dismantling, etc.), and a video screen is recorded. Furthermore, in the terminal taking the terminal 104 in FIG. 1 as an example, in the continuous video screen of the transformed 3D live broadcast screen in the live broadcast room, if a virtual live broadcast object is recorded, you can see the adjusted and played virtual live broadcast object, which further improves the virtual live broadcast experience. Refer to FIG. 9 and FIG. 10, the virtual object of the 3D live broadcast is a vehicle, and the user performs the interactive content triggering operation of “hands apart gesture” in front of the terminal taking the terminal 104 in FIG. 1 as an example, taking the device 101 in FIG. 1 as an example, the device can receive gesture information of “hands apart gesture”, and obtain the disassembled and played object adjustment signal according to the gesture information. Furthermore, the vehicle shown in FIG. 9 is disassembled and played in a 3D space and a video screen is recorded to obtain a frame of video screen in the transformed 3D live broadcast screen shown in FIG. 10.

It can be understood that, according to different interaction trigger timings, the 3D live broadcast screen played on the live broadcast room interface may be an initial 3D live broadcast screen, an interactive 3D live broadcast screen, a subsequent 3D live broadcast screen, a transformed 3D live broadcast screen, or a multi-type interactive 3D live broadcast screen. The multi-type interactive 3D live broadcast screens may be obtained by recording video screens of at least three types of predetermined 3D live broadcast content, virtual interactive content, adding a user's avatar in the live broadcast room, and adjusting and playing the predetermined 3D content. Accordingly, the 3D live broadcast content to be played may include at least three types of predetermined 3D live broadcast content, virtual interactive content, adding a user's avatar in the live broadcast room, and adjusting and playing the predetermined 3D content. The video screen is recorded for the played 3D live broadcast content, and the 3D live broadcast screen is generated and placed on the live broadcast platform. Users can watch multiple types of interactive 3D live broadcast screens in the live broadcast room. It can be understood that due to the change of the recording angle, all or part of the played 3D live broadcast content may be displayed in the continuous video screen in the multi-type interactive 3D live broadcast screen, and displayed from different angles in the 3D space.

In one embodiment, after the step of in response to the live room opening operation, displaying the live broadcast room interface, and playing the 3D live broadcast screen in the live broadcast room interface, the live broadcast method further includes:

In response to a voting operation for the live broadcast room interface, sending voting information to a target device, wherein a direction of a live broadcast content of a live broadcast room corresponding to the live broadcast room interface is determined by the target device according to the voting information.

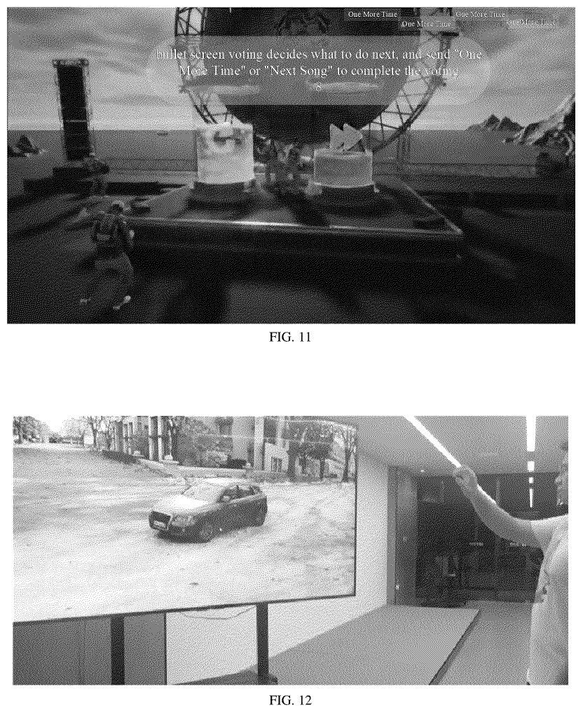

Users can perform voting operations on the live broadcast room interface. The voting operation can be an operation that triggers a predetermined screen casting control, or a screen casting operation that sends a bullet screen, and the screen casting information can be generated through the screen casting operation. Referring to FIG. 11, in an example live broadcast screen, send screen casting bullets as screen casting information in the live broadcast room by sending the screen casting operation of the screen casting (for example, one more time or the next song, etc.). The voting information of the live broadcast platform can be sent to the target device taking the device 101 in FIG. 1 as an example. All voting information in the comprehensive live broadcast room in the target device determines the direction of the live content in the live broadcast room, for example, the current 3D live broadcast screen is replayed, or the 3D live broadcast screen corresponding to the next 3D live broadcast content is played.

Furthermore, in the aforementioned embodiments of the present disclosure, volumetric video (also known as volume video, spatial video, volumetric 3D video or 6-DOF video, etc.) is a technology that generates a 3D dynamic model sequence by capturing information (such as depth information and color information, etc.) in a 3D space. Compared to traditional video, volumetric video adds a concept of space to video. Volumetric video uses a 3D model to better restore the real 3D world, instead of simulating sense of space in the real 3D world with a 2D flat video and moving mirrors. Since the volumetric video is essentially a sequence of 3D models, the users can adjust the video to any viewing angle to watch according to their preferences, which has a higher degree of restoration and immersion than the 2D flat video.

Optionally, in the present disclosure, the 3D model for composing the volumetric video can be reconstructed as follows:

Firstly, obtain color images and depth images of different viewing angles of the subject, as well as camera parameters corresponding to the color images. Then, according to the obtained color image and its corresponding depth image and camera parameters, the neural network model that implicitly expresses the 3D model of the photographed object is trained. Extract the isosurface based on the trained neural network model, realize the 3D reconstruction of the photographed object, and obtain the 3D model of the photographed object.

It should be noted that the neural network model of the architecture adopted in the embodiments of the present disclosure is not specifically limited, and can be selected by those skilled in the art according to actual needs. For example, a MLP (Multilayer Perceptron) without a normalization layer can be selected as the base model for model training.

The 3D model reconstruction method provided by the present disclosure will be described in detail below.

First, multiple color cameras and depth cameras can be used synchronously to photograph the target object (the target object is the shooting object) that needs to be reconstructed from multiple perspectives, so as to obtain color images and corresponding depth images of the target object from multiple different perspectives. Namely, at the same shooting time (the difference between the actual shooting time is less than or equal to the time threshold, it is considered that the shooting time is the same), the color cameras of each viewing angle capture the color image of the target object at the corresponding viewing angle. Correspondingly, a depth image of the target object at the corresponding viewing angle is obtained by shooting the depth camera of each viewing angle. It should be noted that the target object may be any object, including but not limited to living objects such as characters, animals, and plants, or non-living objects such as machinery, furniture, and dolls.

In this way, the color images of the target object at different viewing angles all have corresponding depth images. That is, when shooting, the color camera and the depth camera can adopt the configuration of the camera group, and the color camera of the same viewing angle cooperates with the depth camera to simultaneously shoot the same target object. For example, a photo studio can be built, and the central area of the photo studio is the shooting area. Surrounding the shooting area, multiple sets of color cameras and depth cameras are paired at certain angles in the horizontal and vertical directions. When the target object is in the shooting area surrounded by the color cameras and the depth cameras, the color images and corresponding depth images of the target object at different viewing angles can be obtained by shooting the color cameras and the depth cameras.

In addition, the camera parameters of the color camera corresponding to each color image are further obtained. Wherein, the camera parameters include the internal and external parameters of the color camera, and these parameters can be determined by calibration. The camera internal parameters are parameters related to the characteristics of the color camera, including but not limited to data such as the focal length and pixels of the color camera. The camera external parameters are the parameters of the color camera in the world coordinate system, including but not limited to the position (coordinates) of the color camera and the rotation direction of the camera and other data.

As above, after obtaining a plurality of color images of the target object from different viewing angles and their corresponding depth images at the same shooting moment, the target object can be 3D reconstructed according to these color images and their corresponding depth images. Different from the method of converting depth information into point cloud for 3D reconstruction in the related art, the present disclosure trains a neural network model to realize the implicit expression of the 3D model of the target object. Therefore, the 3D reconstruction of the target object is realized based on the neural network model.

Optionally, present disclosure selects a MLP (Multilayer Perceptron) that does not include a normalization layer as a base model, and performs training in the following manner:

Convert the pixels in each color image to rays based on the corresponding camera parameters. A plurality of sampling points are sampled on the rays, and the first coordinate information of each sampling point and a SDF value of the distance between each sampling point and the pixel are determined. The first coordinate information of the sampling point is input into a base model, and a predicted SDF value and a predicted RGB color value of each sampling point output by the base model are obtained. Based on the first difference between the predicted SDF value and the SDF value, and the second difference between the predicted RGB color value and RGB color value of the pixel, the parameters of the base model are adjusted until the preset stopping condition is satisfied. The base model that satisfies the preset stopping condition is used as the neural network model that implicitly expresses the 3D model of the target object.

Firstly, a pixel in the color image is converted into a ray based on the camera parameters corresponding to the color image, and the ray can be a ray that passes through the pixel and is perpendicular to the color image plane. Then, multiple sample points are sampled on this ray. The sampling process of the sampling point can be performed in two steps. Some sampling points can be uniformly sampled first, and then multiple sampling points can be further sampled at key points based on the depth value of the pixels to ensure that as many sampling points as possible can be sampled near the surface of the model. Then, the first coordinate information of each sampling point in the world coordinate system obtained by sampling and the directional distance (SDF) value of each sampling point are calculated according to the camera parameters and the depth value of the pixel. The SDF value may be the difference between the depth value of the pixel and the distance between the sampling point and the imaging surface of the camera, where the difference is a signed value. When the difference is positive, it means that the sampling point is outside the 3D model. When the difference is negative, it means that the sampling point is inside the 3D model. When the difference is zero, it means that the sampling point is on the surface of the 3D model. Then, after the sampling of the sampling points is completed and the SDF value corresponding to each sampling point is calculated and obtained, the first coordinate information of the sampling points in the world coordinate system is further input into the base model (the base model is configured to map the input coordinate information into SDF values and RGB color values and output them). The SDF value output by the base model is recorded as the predicted SDF value, and the RGB color value output by the base model is recorded as the predicted RGB color value. Then, based on the first difference between the predicted SDF value and the SDF value corresponding to the sampling point, and the second difference between the predicted RGB color value and the RGB color value of the pixel corresponding to the sampling point, the parameters of the base model are adjusted.

In addition, for other pixels in the color image, sampling points are also sampled in the same manner as above. Then, the coordinate information of the sampling point in the world coordinate system is input into the base model to obtain the corresponding predicted SDF value and predicted RGB color value, which are used to adjust the parameters of the base model until a preset stopping condition is met. For example, the preset stop condition can be configured as the number of iterations on the base model reaches the preset number, or the preset stop condition can be configured as the convergence of the base model. When the iteration of the base model satisfies the preset stopping condition, a neural network model that can accurately and implicitly express the 3D model of the photographed object is obtained. Finally, an isosurface extraction algorithm can be used to extract the surface of the 3D model of the neural network model, thereby obtaining a 3D model of the photographed object.

Optionally, in some embodiments, the imaging plane of the color image is determined according to camera parameters; the rays passing through the pixels in the color image and perpendicular to the imaging plane are determined to be rays corresponding to the pixels.

The coordinate information of the color image in the world coordinate system, that is, the imaging plane, can be determined according to the camera parameters of the color camera corresponding to the color image. Then, a ray passing through a pixel in the color image and perpendicular to the imaging plane can be determined as a ray corresponding to the pixel.

Optionally, in some embodiments, a second coordinate information and a rotation angle of the color camera in the world coordinate system are determined according to the camera parameters; the imaging plane of the color image is determined according to the second coordinate information and the rotation angle.

Optionally, in some embodiments, the first number of first sampling points are sampled at equal intervals on the ray. A plurality of key sampling points are determined according to the depth values of the pixels, and a second number of second sampling points are sampled according to the key sampling points. The first number of first sampling points and the second number of second sampling points are determined as a plurality of sampling points obtained by sampling on the ray.

Wherein, firstly uniformly sample n (i.e. the first number) first sampling points on the ray, where n is a positive integer greater than 2. Then, according to the depth value of the aforementioned pixel, a preset number of key sampling points closest to the aforementioned pixel are determined from the n first sampling points, or a distance from the aforementioned pixel is determined from the n first sampling points Key sample points less than the distance threshold. Then, m second sampling points are resampled according to the determined key sampling points, where m is a positive integer greater than 1. Finally, the n+m sampling points obtained by sampling are determined as a plurality of sampling points obtained by sampling on the ray. Wherein, sampling more m sampling points at the key sampling points can make the training effect of the model more accurate on the surface of the 3D model, thereby improving the reconstruction accuracy of the 3D model.

Optionally, in some embodiments, the depth value corresponding to the pixel is determined according to the depth image corresponding to the color image. Calculate the SDF value of each sampling point from the pixel based on the depth value. Calculate the coordinate information of each sampling point according to the camera parameters and the depth value.

Wherein, after sampling multiple sampling points on the ray corresponding to each pixel, for each sampling point, the distance between the shooting position of the color camera and the corresponding point on the target object is determined according to the camera parameters and the depth value of the pixel. Then, based on the distance, the SDF value of each sampling point is calculated one by one, and the coordinate information of each sampling point is calculated.

It should be noted that, after completing the training of the base model, for the coordinate information of any given point, the corresponding SDF value can be predicted by the base model after the training. The predicted SDF value represents the positional relationship (interior, exterior or surface) of the point to the 3D model of the target object. The implicit expression of the 3D model of the target object is realized, and a neural network model for implicitly expressing the 3D model of the target object is obtained.

Finally, the isosurface extraction is performed on the above neural network model. For example, the isosurface extraction algorithm (MC) can be used to draw the surface of the 3D model to obtain the surface of the 3D model. Then, a 3D model of the target object is obtained according to the surface of the 3D model.

The 3D reconstruction solution provided by present disclosure uses a neural network to implicitly model the 3D model of the target object, and adds depth information to improve the speed and accuracy of model training. By using the 3D reconstruction solution provided by the present disclosure, the 3D reconstruction of the shooting object is continuously performed in time sequence, and the 3D models of the shooting object at different times can be obtained. The 3D model sequence formed by the 3D models at different times in time series is the volumetric video obtained by shooting the object. In this way, “volume view shooting” can be performed for any shooting object, and a volumetric video presented with specific content can be obtained. For example, taking a volumetric video of a dancing subject to obtain a volumetric video that allows you to watch the dance of the subject from any angle, and taking a volumetric video of a subject of the teaching to obtain a volumetric video of the subject's teaching can be viewed from any angle, and so on.

It should be noted that, the volumetric video involved in the foregoing embodiments of the present disclosure may be obtained by using the above volumetric video shooting method.

The foregoing embodiments are further described below in conjunction with a process for performing a virtual concert in one scenario. In this scenario, the live broadcast of the virtual concert is realized by applying the live broadcast method in the foregoing embodiments of the present disclosure. In this scenario, the live broadcast of the virtual concert can be realized through the system architecture shown in FIG. 1.

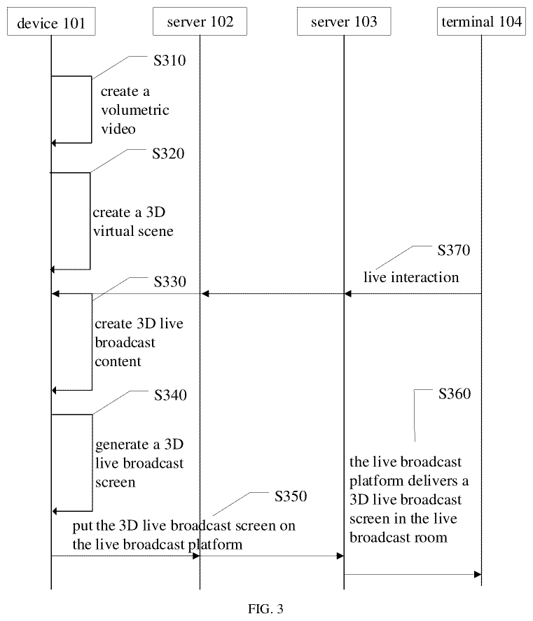

Referring to FIG. 3, a flow of implementing a virtual concert by applying the live broadcast method in the foregoing embodiment of the present disclosure in this scenario is shown, and the flow includes steps S310 to S380.

Step S310, create a volumetric video.

Specifically, a volumetric video is a 3D dynamic model sequence used to show the live broadcast behavior of a 3D live broadcast object. For the real live broadcast object (in this scenario, the specific singer) that performs live broadcast (in this scenario, the specific performance is singing), the color information, material information, depth information and other data are captured and collected. Based on the existing volumetric video generation algorithm, the volumetric video used to display the live broadcast behavior of the 3D live broadcast object (that is, the 3D virtual live broadcast object corresponding to the real live broadcast object) can be generated. The volumetric video can be produced in the device 101 shown in FIG. 1 or other computing devices.

Step S320, create a 3D virtual scene.

Specifically, the 3D virtual scene is used to display the contents of the 3D scene. The 3D scene content may include a 3D virtual scene (eg, a scene such as a stage) and virtual interactive content (eg, 3D special effects). The 3D virtual scene can be created in the device 101 or other computing devices through 3D software or programs.

Step S330, create 3D live broadcast content. Wherein, the 3D live broadcast content can be produced in the device 101 shown in FIG. 1.

Specifically, the device 101 can: obtain the volumetric video (i.e. produced in step 310), and the volumetric video is configured to display a live broadcast behavior of a 3D live object; obtain the 3D virtual scene (i.e. produced in step 320), and the 3D virtual scene is configured to display a 3D scene content; combine the volumetric video and the 3D virtual scene to obtain a 3D live broadcast content including the live broadcast behavior and the 3D scene content.

The volumetric video can be put into a virtual engine through a plug-in, and the 3D virtual scene can also be directly placed in the virtual engine. Relevant users can perform combined adjustment operations for the volumetric video and 3D virtual scene in the virtual engine, such as position adjustment, size adjustment, rotation adjustment, and rendering operations. After the adjustment is completed, the relevant user triggers the combination confirmation operation, and the adjusted volumetric video and the 3D virtual scene are combined into a whole in the device to obtain at least one 3D live broadcast content.

In one embodiment, combining the volumetric video and the 3D virtual scene to obtain the 3D live broadcast content including the live broadcast behavior and the 3D scene content includes: obtaining a volumetric video description parameter of the volumetric video; obtaining a virtual scene description parameter of the 3D virtual scene; jointly analyzing the volumetric video description parameter and the virtual scene description parameter to obtain at least one content combination parameter; and combining the volumetric video and the 3D virtual scene according to the content combination parameter to obtain at least one 3D live broadcast content including the live broadcast behavior and the 3D scene content. The volumetric video description parameter is a related parameter that can describe volumetric video. The volumetric video description parameters may include object information (such as gender, name, etc.) of the 3D live broadcast object in the volumetric video, and live broadcast behavior information (such as dancing, singing, etc.). The virtual scene description parameter is a related parameter that can describe the content of the 3D scene in the 3D virtual scene. The virtual scene description parameters may include item information of scene items included in the 3D scene content (for example, item name and item color, etc.), and relative positional relationship information between scene items. The content combination parameter is a parameter for combining the volumetric video and the 3D virtual scene. The content combination parameters may include the volume size corresponding to the volumetric video in the 3D space, the placement position of the scene items relative to the 3D virtual scene, and the item volume size of the scene items in the 3D virtual scene. Different content combination parameters have different parameters. The volumetric video and the 3D virtual scene are combined according to each content combination parameter to obtain a 3D live broadcast content respectively.

Step S340, generate a 3D live broadcast screen. Wherein, a 3D live broadcast screen may be generated in the device 101 as shown in FIG. 1.

Specifically, in device 101: a 3D live broadcast screen is generated based on the 3D live broadcast content, and the 3D live broadcast screen is used for playing on the live broadcast platform. Generating a 3D live video screen based on the 3D live broadcast content may include: playing the 3D live broadcast content; and transforming according to a target angle in a 3D space, and recording a video screen of a played 3D live broadcast content to obtain the 3D live broadcast screen.

The 3D live broadcast content is played on the device, and the 3D live broadcast content can dynamically display the live broadcast behavior of the 3D live broadcast object and the 3D scene content. By transforming the virtual camera according to the target angle in the 3D space, the 3D live broadcast content can be continuously recorded as a video screen, and then the 3D live video screen can be obtained.

In one way, after step S330, the step of transforming according to the target angle in the 3D space, and recording the video screen of the played 3D live broadcast content to obtain the 3D live broadcast screen includes: transforming a recording angle in the 3D space following the virtual camera track, and recording the video screen of the 3D live broadcast content to obtain the 3D live broadcast screen. The device 101 moves the virtual camera along the track of the virtual camera, and then converts the recording angle in the 3D space, records the video screen of the 3D live broadcast content, and obtains the 3D live video screen, enabling the user to follow the virtual camera track for multi-angle live viewing.

In another way, the step of transforming according to the target angle in the 3D space, and recording the video screen of the played 3D live broadcast content to obtain the 3D live broadcast screen includes: transforming a recording angle in the 3D space following a gyroscope in the (eg, the device 101 or the terminal 104), and recording the video screen of the 3D live broadcast content to obtain the 3D live broadcast screen. It can realize 360-degree live viewing in any direction based on the gyroscope.

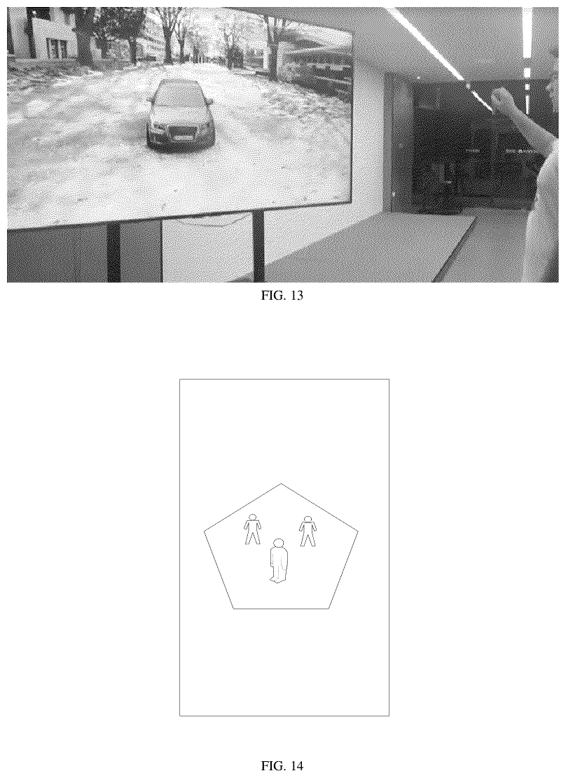

In another way, the step of transforming according to the target angle in the 3D space, and recording the video screen of the played 3D live broadcast content to obtain the 3D live broadcast screen includes: transforming a recording angle in the 3D space according to a change operation of a viewing angle sent by a live client in the live platform; and recording the video screen of the played 3D live broadcast content to obtain the 3D live broadcast screen. When watching the live broadcast in the live broadcast room in the live broadcast client, the user can implement the viewing angle change operation by rotating the viewing device (i.e. the terminal 104) or moving the viewing angle on the screen. The device outside the live broadcast platform (i.e. device 101) transforms the recording angle in the 3D space according to the viewing angle change operation, and records video screens of the 3D live broadcast content, and the 3D live broadcast screens corresponding to different users can be obtained. Referring to FIG. 12 and FIG. 13, at a first moment, the video screen displayed in the 3D live broadcast screen is as shown in FIG. 12. At this time, the user performs a viewing angle change operation based on sliding the right hand from left to right in front of the viewing device (i.e. the terminal 104), and the viewing angle operation information generated by the viewing angle change operation is sent to the device outside the live broadcast platform (i.e. the device 101). The device outside the live broadcast platform (i.e. device 101), according to the viewing angle operation information, turns the 3D live broadcast content from the angle shown in FIG. 12 and records the video screen, so that, the recording angle is transformed to obtain a frame of video screen in the 3D live broadcast screen as shown in FIG. 13.

Furthermore, the 3D live broadcast content includes a predetermined 3D content and at least one virtual interactive content; the step of playing the 3D live broadcast content includes: playing the predetermined 3D content in the 3D live broadcast content; and in response to detecting an interaction trigger signal in the live broadcast platform, playing the virtual interaction content corresponding to the interaction trigger signal relative to the predetermined 3D content.

The predetermined 3D content can be a predetermined portion of the regularly played content. The predetermined 3D content can include some or all in volumetric video, as well as some 3D scenes in the 3D virtual scene. The predetermined 3D content is played, and the generated 3D live broadcast screen is put on the live broadcast platform, and the user can watch the screen corresponding to the predetermined 3D content in the live broadcast room. The 3D virtual scene further includes at least one kind of virtual interactive content, and the at least one kind of virtual interactive content is played when triggered. In the live broadcast room of the live broadcast client, the user can trigger the interaction trigger signal on the live broadcast platform through related operations (such as sending gifts, etc.). When the local device outside the live broadcast platform (i.e. the device 101) detects the interaction trigger signal in the live broadcast platform, the virtual interaction content corresponding to the interaction trigger signal is determined from at least one type of virtual interaction content. Then, the virtual interactive content corresponding to the interactive trigger signal may be played at a predetermined position relative to the predetermined 3D content. Wherein, different interaction trigger signals correspond to different virtual interaction contents. The virtual interactive content can be a 3D special effect, for example, a 3D firework or a 3D barrage or a 3D gift and other special effects. The production method of virtual interactive content may be the production method of traditional CG special effects. For example, effect maps can be made using flat software, and special effects sequence diagrams can be made using special effects software (such as AE, CB, PI, etc.), and characteristic models can be made using 3D software (eg, 3DMAX, MAYA, XSI, LW, etc.), and the required special effects visual effects can be realized through program code in game engines (such as UE4, UE5, Unity, etc.).

Furthermore, the step of playing the 3D live broadcast content includes: playing the predetermined 3D content in the 3D live broadcast content; and in response to detecting that a user has joined the live broadcast room, displaying an avatar of the user at a predetermined position relative to the predetermined 3D content. After the user enters the live broadcast room, the local device outside the live broadcast platform displays the user's exclusive avatar at a predetermined position relative to the predetermined 3D content for the user. The 3D avatar forms a part of the 3D live broadcast content, which further enhances the virtual live broadcast experience.

Furthermore, the user's interactive information in the live broadcast room can be obtained through the interface provided by the live broadcast platform (such as giving gifts or likes or communication information in the communication area, etc.). Classify the interaction information to obtain the interaction type of the user. Different interaction types correspond to different points. In the end, the points of all users in the live broadcast room will be counted and ranked, and the top users with predetermined names will get special avatars (such as avatars with golden glitter effects).

Furthermore, after the user enters the live broadcast room, identification information such as the user ID or name of the user can be collected, and the identification information can be displayed at a predetermined position relative to the avatar. For example, a user ID corresponding to an exclusive avatar is generated to be placed on the top of the avatar's head.

Furthermore, after the playing of the predetermined 3D content in the 3D live broadcast content, the method further includes: in response to detecting a content adjustment signal in the live broadcast platform, adjusting and playing the predetermined 3D content. In the live broadcast room in the live broadcast client, users can trigger content adjustment signals on the live broadcast platform through related operations (such as sending gifts, etc.). When the local device outside the live broadcast platform detects the content adjustment signal in the live broadcast platform, it adjusts and plays the predetermined 3D content. For example, the virtual 3D live broadcast object or the signal in the virtual live broadcast scene content can be dynamically adjusted, such as zooming in, zooming out, or changing from time to time to small.

Furthermore, the predetermined 3D content includes a virtual 3D live broadcast object in the volumetric video; the content adjustment signal includes an object adjustment signal; the step of in response to detecting the content adjustment signal in the live broadcast platform, adjusting and playing the predetermined 3D content includes: in response to detecting the object adjustment signal in the live broadcast platform, dynamically adjusting the virtual 3D live broadcast object. If the local device outside the live broadcast platform detects the object adjustment signal, it will play the virtual live broadcast object for dynamic adjustment (Dynamic adjustments such as zooming in, zooming out, transforming large and small, or particle effects), and then the adjusted and played virtual live broadcast object can be seen in the live broadcast room.

The 3D live broadcast screen is played in the live broadcast room in the live broadcast platform. After the predetermined 3D content in the 3D live broadcast content is played, the device 101 can: obtain interaction information in the live broadcast room (Wherein, the device 101 can obtain interaction information from the interface provided by the live broadcast platform (i.e. the server 103) through the established relay information server (i.e. the server 102)). The interaction information is classified to obtain an event trigger signal in the live broadcast platform. The event trigger signal includes at least one of an interaction trigger signal and a content adjustment signal. The interactive information in the live broadcast room, such as giving gifts or likes, or the communication information in the communication area, etc. The content interaction information in the live broadcast room is usually diverse. By classifying the interactive information to determine the corresponding event trigger signal, the corresponding interactive content or dynamic adjustment operation can be accurately triggered. For example, by classifying the interaction information, it can be determined that the event trigger signal corresponding to the interaction information is the interaction trigger signal for sending fireworks gifts, so that, 3D firework special effects (virtual interactive content) can be played.

Step S350, put the 3D live broadcast screen on the live broadcast platform. The device 101 transmits the 3D live broadcast screen to the server 103 through a preset interface, or the device 101 transfers the 3D live broadcast screen to the server 103 through the server 102.

Step S360, the live broadcast platform delivers a 3D live broadcast screen in the live broadcast room. Specifically, in the terminal 104: in response to the live room opening operation, the live broadcast room interface is displayed, and the 3D live broadcast screen is played in the live broadcast room interface. The server 103 may transmit the 3D live broadcast screen to the live broadcast client in the terminal 104. In the live broadcast client, the 3D live broadcast screen is played on the live broadcast room interface corresponding to the live broadcast room opened by the user through the live room opening operation. Furthermore, the 3D live broadcast screen can be played on the live broadcast platform.

Wherein, in one way, the step of in response to the live room opening operation, displaying the live broadcast room interface includes: displaying a live broadcast client interface, where at least one live broadcast room can be displayed in the live broadcast client interface; in response to the live broadcast room opening operation for a target live broadcast room in the at least one live broadcast room, the live broadcast room interface of the target live broadcast room is displayed. Referring to FIG. 4 and FIG. 5, in an example, the displayed live broadcast client interface is as shown in FIG. 4, and the live broadcast client interface displays at least 4 live broadcast rooms. After the user selects a target live broadcast room and opens it through the live broadcast room open operation, the displayed live broadcast room interface of the target live broadcast room is shown in FIG. 5.

In addition, in another way, the step of in response to the live room opening operation, displaying the live broadcast room interface includes: after the user opens the live broadcast client through the live room opening operation, the live broadcast room interface as shown in FIG. 5 is directly displayed in the client terminal.

It can be understood that a manner of displaying the live broadcast room interface through the live room opening operation may also be other optional and implementable manners.

Step S370, live interaction. Specifically, the relevant interactive operations of the user in the live broadcast room can trigger the device 101 to dynamically adjust the 3D live broadcast content. The device 101 may generate a 3D live broadcast screen based on the adjusted 3D live broadcast content in real time.

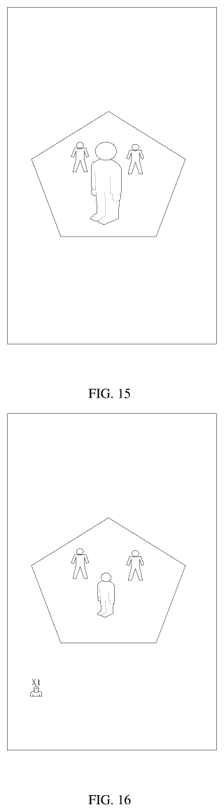

In one example, device 101 can: obtain the interaction information in the live broadcast room (wherein, the device 101 can obtain the interaction information from the interface provided by the live broadcast platform (i.e. the server 103) through the established relay information server (i.e. the server 102)), and classify the interaction information to obtain an event trigger signal in the live broadcast platform. The event trigger signal includes at least one of an interaction trigger signal and a content adjustment signal. Each event trigger signal triggers the device 101 to adjust the 3D live broadcast content accordingly. Furthermore, in the 3D live broadcast screen played in the live broadcast room, the adjusted 3D live broadcast content (for example, virtual interactive content or a virtual live broadcast object adjusted and played) can be viewed. Referring to FIG. 14 and FIG. 15, in one scenario, the 3D live broadcast screen before “Dynamic adjustment of 3D live broadcast content” played in the live broadcast room interface of a certain user is shown in FIG. 14. The 3D live broadcast screen after “dynamically adjusting the 3D live broadcast content” played in the user's live broadcast room interface is shown in FIG. 15. The 3D live broadcast object corresponding to the singer in the screen played in FIG. 15 is enlarged.

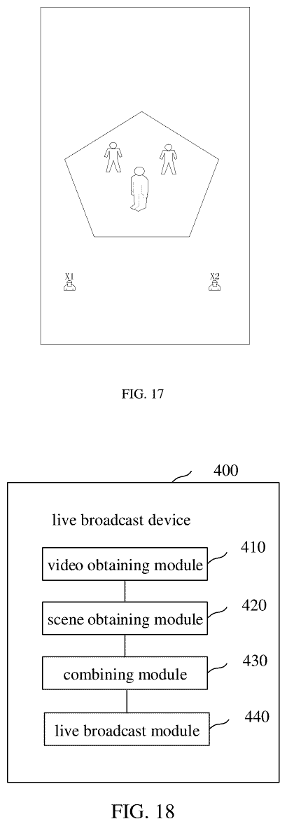

In another example, after the user enters the live broadcast room, the device 101 detects that the user has joined the live broadcast room, and the avatar of the user is displayed at a predetermined position relative to the predetermined 3D content, and the avatar of the user can be viewed in the 3D live broadcast screen played in the live broadcast room. Referring to FIG. 16 and FIG. 17, in one scenario, before the X2 user joins the live broadcast room, the 3D live broadcast screen before “dynamic adjustment of 3D live broadcast content” played in the X1 user's live broadcast room interface is shown in FIG. 16. In the screen of FIG. 16, only the avatar of the X1 user is displayed, and the avatar of the X2 user is not displayed. After the X2 user joins the live broadcast room, the 3D live broadcast screen after “Dynamic adjustment of the 3D live broadcast content” played on the X1 user's live broadcast room interface is shown in FIG. 17. The avatars of the X1 user and the X2 user are displayed on the screen played in FIG. 17.

Furthermore, after the live broadcast of the 3D live broadcast content in the live broadcast room ends, the device 101 may decide the direction of the content through the voting of the users in the live broadcast room. For example, after the live broadcast is over, the user's vote can be used to decide whether the next live broadcast or the previous live broadcast or a replay, etc.

In this way, by applying the foregoing embodiments of the present disclosure in this scenario, at least the following beneficial effects can be obtained: by obtaining the live behavior volumetric video of the 3D live broadcast object used to display the singer, and the volumetric video can directly and excellently express the live broadcast behavior in the form of a 3D dynamic model sequence. Therefore, the volumetric video can be directly and conveniently combined with the 3D virtual scene to obtain the 3D live content as the 3D content source. The 3D content source can very well represent the live content including the live performance of the singer and the content of the 3D scene. The action behavior and other live content in the generated 3D live screen are highly natural and can display the live content from multiple angles. Furthermore, the virtual live broadcast effect of the concert can be effectively improved.

In order to better implement the live broadcast method provided by the embodiment of the present disclosure, the embodiment of the present disclosure further provides a live broadcast device based on the above-mentioned live broadcast method. Wherein, the meaning of the noun is the same as in the above live broadcast method. The meanings of the terms are the same as those in the above-mentioned live broadcast method, and for specific implementation details, please refer to the description in the method embodiment. A block diagram of a live broadcast device according to an embodiment of the present disclosure is shown in FIG. 18.

As shown in FIG. 18, the live broadcast device 400 may include a video obtaining module 410, a scene obtaining module 420, a combining module 430 and a live broadcast module 440.

The video obtaining module is configured to obtain a volumetric video, and the volumetric video is configured to display a live broadcast behavior of a 3D live object; the scene obtaining module is configured to obtain a 3D virtual scene, and the 3D virtual scene is configured to display a 3D scene content; the combining module is configured to combine the volumetric video and the 3D virtual scene to obtain a 3D live broadcast content including the live broadcast behavior and the 3D scene content; and the live broadcast module is configured to generate a 3D live broadcast screen based on the 3D live broadcast content, and the 3D live broadcast screen is configured to play on a live broadcast platform.

In some embodiments of the present disclosure, the live broadcast module includes: a playing unit, configured to play the 3D live broadcast content; and a recording unit, configured to transform according to a target angle in a 3D space, and record a video screen of a played 3D live broadcast content to obtain the 3D live broadcast screen.

In some embodiments of the present disclosure, a virtual camera track is disposed on the 3D live broadcast content; the recording unit is configured to transform a recording angle in the 3D space following the virtual camera track, and record the video screen of the 3D live broadcast content to obtain the 3D live broadcast screen.

In some embodiments of the present disclosure, the recording unit is configured to transform a recording angle in the 3D space following a gyroscope, and record the video screen of the 3D live broadcast content to obtain the 3D live broadcast screen.

In some embodiments of the present disclosure, the recording unit is configured to transform a recording angle in the 3D space according to a change operation of a viewing angle sent by a live client in the live platform, and record the video screen of the played 3D live broadcast content to obtain the 3D live broadcast screen.

In some embodiments of the present disclosure, the 3D live broadcast content includes a predetermined 3D content and at least one virtual interactive content; the playing unit is configured to play the predetermined 3D content in the 3D live broadcast content; and in response to detecting an interaction trigger signal in the live broadcast platform, play the virtual interaction content corresponding to the interaction trigger signal relative to the predetermined 3D content.

In some embodiments of the present disclosure, the 3D live broadcast content includes a predetermined 3D content; the 3D live broadcast screen is played in the live broadcast room on the live broadcast platform; the playing unit is configured to play the predetermined 3D content in the 3D live broadcast content; and in response to detecting that a user has joined the live broadcast room, display an avatar of the user at a predetermined position relative to the predetermined 3D content.

In some embodiments of the present disclosure, the device further includes an adjustment unit, the adjustment unit is configured to in response to detecting a content adjustment signal in the live broadcast platform, adjust and play the predetermined 3D content.

In some embodiments of the present disclosure, the predetermined 3D content includes a virtual 3D live broadcast object in the volumetric video; the content adjustment signal includes an object adjustment signal; the adjustment unit is configured to in response to detecting the object adjustment signal in the live broadcast platform, dynamically adjust the virtual 3D live broadcast object.

In some embodiments of the present disclosure, the 3D live broadcast screen is played in the live broadcast room on the live broadcast platform; the device further includes an signal determination unit, the signal determination unit is configured to obtain interaction information in the live broadcast room; and classify the interaction information to obtain an event trigger signal in the live broadcast platform, and the event trigger signal includes at least one of an interaction trigger signal and a content adjustment signal.

In some embodiments of the present disclosure, the combining module includes a first combining unit, configured to adjust the volumetric video and the 3D virtual scene according to the combined adjustment operation of the volumetric video and the 3D virtual scene; and in response to a combination confirmation operation, combine the volumetric video with the 3D virtual scene to obtain at least one 3D live broadcast content including the live broadcast behavior and the 3D scene content.

In some embodiments of the present disclosure, the combining module includes a second combining unit, configured to obtain a volumetric video description parameter of the volumetric video; obtain a virtual scene description parameter of the 3D virtual scene; jointly analyze the volumetric video description parameter and the virtual scene description parameter to obtain at least one content combination parameter; and combine the volumetric video and the 3D virtual scene according to the content combination parameter to obtain at least one 3D live broadcast content including the live broadcast behavior and the 3D scene content.

In some embodiments of the present disclosure, the second combining unit is configured to obtain a terminal parameter of a terminal used by a user in the live broadcast platform and a user description parameter of the user; and jointly analyze the volumetric video description parameter, the virtual scene description parameter, the terminal parameter, and the user description parameter to obtain at least one content combination parameter.

In some embodiments of the present disclosure, the 3D live broadcast content is at least one, and different 3D live broadcast contents are configured to generate 3D live broadcast screen recommended to users of different categories.

According to an embodiment of the present disclosure, a live broadcast method is provided, the live broadcast method includes: in response to a live room opening operation, displaying a live broadcast room interface, and playing a 3D live broadcast screen in the live broadcast room interface, and the 3D live broadcast screen is generated according to the live broadcast method described in any one of the foregoing embodiments.

According to an embodiment of the present disclosure, a live broadcast device is provided, the live broadcast device includes: a live room display module, configured to in response to a live room opening operation, display a live broadcast room interface, and play a 3D live broadcast screen in the live broadcast room interface, and the 3D live broadcast screen is generated according to the live broadcast method described in any one of the foregoing embodiments.

In some embodiments of the present disclosure, the live room display module is configured to: displaying a live broadcast client interface, and displaying at least one live broadcast room in the live broadcast client interface; and in response to the live room opening operation for a target live broadcast room in the at least one live broadcast room, displaying the live broadcast room interface of the target live broadcast room.

In some embodiments of the present disclosure, the live room display module is configured to: in response to the live room opening operation, displaying the live broadcast room interface, and displaying an initial 3D live broadcast screen in the live broadcast room interface, and the initial 3D live broadcast screen is obtained by recording a video screen of the predetermined 3D content played in the 3D live broadcast content; and in response to an interactive content triggering operation on the live broadcast room interface, displaying an interactive 3D live broadcast screen in the live broadcast room interface, and the interactive 3D live broadcast screen is obtained by recording a video screen of a played predetermined 3D content and a virtual interactive content triggered by the interactive content triggering operation, and the virtual interactive content belongs to the 3D live broadcast content.

In some embodiments of the present disclosure, the live room display module is configured to: in response to a user joining the live broadcast room corresponding to the live broadcast room interface, displaying a subsequent 3D live broadcast screen in the live broadcast room interface, and the subsequent 3D live broadcast screen is obtained by recording a video screen of the played predetermined 3D content and an avatar of the user who joined the live broadcast room.

In some embodiments of the present disclosure, the live room display module is configured to: in response to the interactive content triggering operation on the live broadcast room interface, displaying a transformed 3D live broadcast screen in the live broadcast room interface, and the transformed 3D live broadcast screen is obtained by recording a video screen of the predetermined 3D content adjusted and played, and an adjustment and playing of the 3D content is triggered by the interactive content triggering operation.

In some embodiments of the present disclosure, the device further includes a voting module, the voting module is configured to: in response to a voting operation for the live broadcast room interface, sending voting information to a target device, wherein a direction of a live broadcast content of a live broadcast room corresponding to the live broadcast room interface is determined by the target device according to the voting information.

It should be noted that although several modules or units of the device for action performance are mentioned in the above detailed description, this division is not mandatory. Actually, according to embodiments of the present disclosure, the features and functions of two or more modules or units described above may be embodied in one module or unit. Conversely, the features and functions of one module or unit described above may be further divided into multiple modules or units to be embodied.

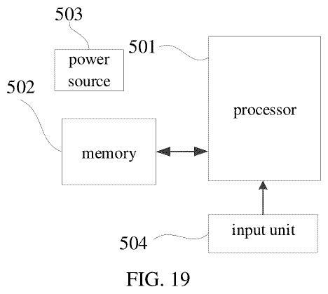

In addition, an embodiment of the present disclosure further provides an electronic device, where the electronic device may be a terminal or a server. As shown in FIG. 19, a schematic structural diagram of an electronic device involved in an embodiment of the present disclosure is shown, specifically:

The electronic device may include a processor 501 having one or more processing cores, a memory 502 having one or more computer-readable storage medium, a power source 503 and an input unit 504 and other components. Those skilled in the art can understand that, the structure of the electronic device shown in FIG. 19 does not constitute a limitation to the electronic device, and the electronic device may include more or fewer components than shown, or combine certain components, or a different arrangement of components. Wherein:

The processor 501 is the control center of the electronic device. The processor 501 connects various parts of the entire computer device using various interfaces and lines, and executes software programs and/or modules stored in the memory 502. In addition, the processor 501 recalls the data stored in the memory 502, performs various functions of the computer device and processes the data, so as to monitor the electronic device as a whole. Optionally, processor 501 may include one or more processing cores. Preferably, the processor 501 can integrate an application processor and a modem processor. Wherein, the application processor mainly processes the operating system, user pages, and application programs. The modem processor mainly deals with wireless communication. It can be understood that, the above-mentioned modulation and demodulation processor may not be integrated into the processor 501.

The memory 502 may be used to store software programs and modules. The processor 501 executes various functional applications and data processing by executing software programs and modules stored in the memory 502. The memory 502 may mainly include a stored program area and a stored data area. Wherein, the storage program area may store an operating system, an application program required for at least one function (such as a sound playback function, an image playback function, etc.), and the like. The storage data area may store data or the like created according to the use of the computer device. Additionally, memory 502 may include high-speed random access memory, and may also include non-volatile memory, such as at least one magnetic disk storage device, flash memory device, or other volatile solid state storage device. Accordingly, memory 502 may also include a memory controller to provide processor 501 access to memory 502.

The electronic device also includes the power source 503 for powering the various components. Preferably, the power source 503 may be logically connected to the processor 501 through a power management system, so that functions such as charging, discharging, and power consumption management are implemented through the power management system. The power source 503 may also include one or more direct-current or alternating current power sources, recharging systems, power failure detection circuits, power converters or inverters, power status indicators, and any other components.

The electronic device may also include the input unit 504. The input unit 504 may be used to receive input numerical or character information and generate keyboard, mouse, joystick, optical or trackball signal input related to user settings and function control.

Although not shown, the electronic device may further include a display unit and the like, which will not be described here. Specifically, in this embodiment, the processor 501 in the electronic device loads the executable files corresponding to the processes of one or more computer programs into the memory 502 according to the following instructions, and the processor 501 runs the computer program stored in the memory 502, thereby implementing various functions according to the foregoing embodiments of the present disclosure.

For example, the processor 501 can execute: obtain a volumetric video, and the volumetric video is configured to display a live broadcast behavior of a 3D live object; obtain a 3D virtual scene, and the 3D virtual scene is configured to display a 3D scene content; combine the volumetric video and the 3D virtual scene to obtain a 3D live broadcast content including the live broadcast behavior and the 3D scene content; and generate a 3D live broadcast screen based on the 3D live broadcast content, and the 3D live broadcast screen is configured to play on a live broadcast platform.

In some embodiments, the step of generating the 3D live broadcast screen based on the 3D live broadcast content includes: playing the 3D live broadcast content; and transforming according to a target angle in a 3D space, and recording a video screen of a played 3D live broadcast content to obtain the 3D live broadcast screen.

In some embodiments, a virtual camera track is disposed on the 3D live broadcast content. The step of transforming according to the target angle in the 3D space, and recording the video screen of the played 3D live broadcast content to obtain the 3D live broadcast screen includes: transforming a recording angle in the 3D space following the virtual camera track, and recording the video screen of the 3D live broadcast content to obtain the 3D live broadcast screen.

In some embodiments, the step of transforming according to the target angle in the 3D space, and recording the video screen of the played 3D live broadcast content to obtain the 3D live broadcast screen includes: transforming a recording angle in the 3D space following a gyroscope, and recording the video screen of the 3D live broadcast content to obtain the 3D live broadcast screen.

In some embodiments, the step of transforming according to the target angle in the 3D space, and recording the video screen of the played 3D live broadcast content to obtain the 3D live broadcast screen includes: transforming a recording angle in the 3D space according to a change operation of a viewing angle sent by a live client in the live platform; and recording the video screen of the played 3D live broadcast content to obtain the 3D live broadcast screen.

In some embodiments, the 3D live broadcast content includes a predetermined 3D content and at least one virtual interactive content. The step of playing the 3D live broadcast content includes: playing the predetermined 3D content in the 3D live broadcast content; and in response to detecting an interaction trigger signal in the live broadcast platform, playing the virtual interaction content corresponding to the interaction trigger signal relative to the predetermined 3D content.

In some embodiments, the 3D live broadcast content includes a predetermined 3D content; the 3D live broadcast screen is played in the live broadcast room on the live broadcast platform. The step of playing the 3D live broadcast content includes: playing the predetermined 3D content in the 3D live broadcast content; and in response to detecting that a user has joined the live broadcast room, displaying an avatar of the user at a predetermined position relative to the predetermined 3D content.

In some embodiments, after the step of playing the predetermined 3D content in the 3D live broadcast content, the live broadcast method further includes: in response to detecting a content adjustment signal in the live broadcast platform, adjusting and playing the predetermined 3D content.

In some embodiments, the predetermined 3D content includes a virtual 3D live broadcast object in the volumetric video; the content adjustment signal includes an object adjustment signal; the step of in response to detecting the content adjustment signal in the live broadcast platform, adjusting and playing the predetermined 3D content includes: in response to detecting the object adjustment signal in the live broadcast platform, dynamically adjusting the virtual 3D live broadcast object.

In some embodiments, the 3D live broadcast screen is played in the live broadcast room on the live broadcast platform. After the step of playing the predetermined 3D content in the 3D live broadcast content, the live broadcast method further includes: obtaining interaction information in the live broadcast room; and classifying the interaction information to obtain an event trigger signal in the live broadcast platform, and the event trigger signal includes at least one of an interaction trigger signal and a content adjustment signal.

In some embodiments, the step of combining the volumetric video and the 3D virtual scene to obtain the 3D live broadcast content including the live broadcast behavior and the 3D scene content includes: adjusting the volumetric video and the 3D virtual scene according to the combined adjustment operation of the volumetric video and the 3D virtual scene; and in response to a combination confirmation operation, combining the volumetric video with the 3D virtual scene to obtain at least one 3D live broadcast content including the live broadcast behavior and the 3D scene content.

In some embodiments, the step of combining the volumetric video and the 3D virtual scene to obtain the 3D live broadcast content including the live broadcast behavior and the 3D scene content includes: obtaining a volumetric video description parameter of the volumetric video; obtaining a virtual scene description parameter of the 3D virtual scene; jointly analyzing the volumetric video description parameter and the virtual scene description parameter to obtain at least one content combination parameter; and combining the volumetric video and the 3D virtual scene according to the content combination parameter to obtain at least one 3D live broadcast content including the live broadcast behavior and the 3D scene content.

In some embodiments, the step of jointly analyzing the volumetric video description parameter and the virtual scene description parameter to obtain at least one content combination parameter includes: obtaining a terminal parameter of a terminal used by a user in the live broadcast platform and a user description parameter of the user; and jointly analyzing the volumetric video description parameter, the virtual scene description parameter, the terminal parameter, and the user description parameter to obtain at least one content combination parameter.

In some embodiments, the 3D live broadcast content is at least one, and different 3D live broadcast contents are configured to generate 3D live broadcast screen recommended to users of different categories.

In some embodiments, for another example, the processor 501 may execute: in response to a live room opening operation, displaying a live broadcast room interface, and playing a 3D live broadcast screen in the live broadcast room interface, and the 3D live broadcast screen is generated according to the live broadcast method described in any embodiment of the present disclosure.

In some embodiments, the step of in response to the live room opening operation, displaying the live broadcast room interface includes: displaying a live broadcast client interface, and displaying at least one live broadcast room in the live broadcast client interface; and in response to the live room opening operation for a target live broadcast room in the at least one live broadcast room, displaying the live broadcast room interface of the target live broadcast room.

Those of ordinary skill in the art can understand that all or part of the steps in the various methods of the above embodiments can be implemented by a computer program, or by a computer program controlling related hardware. The computer program can be stored in a computer-readable storage medium and loaded and executed by a processor.

For this purpose, one embodiment of the present disclosure further provides a computer-readable storage medium on which a computer program is stored. The computer program can be loaded by the processor to execute the steps in any of the methods provided by the embodiments of the present disclosure.

Wherein, the computer-readable storage medium may include: a ROM (Read Only Memory), a RAM (Random Access Memory), a magnetic disk or an optical disk, and the like.

Due to the computer program stored in the computer-readable storage medium, the steps in any of the methods provided in the embodiments of the present disclosure can be executed. Therefore, it can achieve the beneficial effects that can be achieved by the methods provided in the embodiments of the present disclosure. For details, refer to the previous embodiments, which will not be repeated here.

According to one aspect of the present disclosure, a computer program product or computer program is provided. The computer program product or computer program includes computer instructions stored in a computer-readable storage medium. The processor of the computer device reads the computer instructions from the computer-readable storage medium, and the processor executes the computer instructions, so that the computer device executes the methods provided in the various optional implementations in the foregoing embodiments of the present disclosure.

Other embodiments of the present disclosure will readily occur to those skilled in the art upon consideration of the specification and practice of the embodiments disclosed herein. The present disclosure is intended to cover any variations, uses, or adaptations of the present disclosure. These modifications, uses or adaptations follow the general principles of the present disclosure and include common knowledge or conventional technical means in the technical field not disclosed in the present disclosure.

It should be understood that the present disclosure is not limited to the embodiments that have been described above and illustrated in the accompanying drawings, but various modifications and changes may be made without departing from the scope thereof.

1. A live broadcast method, comprising:
obtaining a volumetric video, and the volumetric video is configured to display a live broadcast behavior of a 3D live object;
obtaining a 3D virtual scene, and the 3D virtual scene is configured to display a 3D scene content;
combining the volumetric video and the 3D virtual scene to obtain a 3D live broadcast content including the live broadcast behavior and the 3D scene content; and
generating a 3D live broadcast screen based on the 3D live broadcast content, and the 3D live broadcast screen is configured to play on a live broadcast platform.

2. The method of claim 1, the step of generating the 3D live broadcast screen based on the 3D live broadcast content comprises:
playing the 3D live broadcast content; and
transforming according to a target angle in a 3D space, and recording a video screen of a played 3D live broadcast content to obtain the 3D live broadcast screen.

3. The method of claim 2, a virtual camera track is disposed on the 3D live broadcast content;
the step of transforming according to the target angle in the 3D space, and recording the video screen of the played 3D live broadcast content to obtain the 3D live broadcast screen comprises:
transforming a recording angle in the 3D space following the virtual camera track, and recording the video screen of the 3D live broadcast content to obtain the 3D live broadcast screen.

4. The method of claim 2, the step of transforming according to the target angle in the 3D space, and recording the video screen of the played 3D live broadcast content to obtain the 3D live broadcast screen comprises:
transforming a recording angle in the 3D space following a gyroscope, and recording the video screen of the 3D live broadcast content to obtain the 3D live broadcast screen.

5. The method of claim 2, the step of transforming according to the target angle in the 3D space, and recording the video screen of the played 3D live broadcast content to obtain the 3D live broadcast screen comprises:
transforming a recording angle in the 3D space according to a change operation of a viewing angle sent by a live client in the live platform; and recording the video screen of the played 3D live broadcast content to obtain the 3D live broadcast screen.

6. The method of claim 2, the 3D live broadcast content comprises a predetermined 3D content and at least one virtual interactive content;
the step of playing the 3D live broadcast content comprises:
playing the predetermined 3D content in the 3D live broadcast content; and
in response to detecting an interaction trigger signal in the live broadcast platform, playing the virtual interaction content corresponding to the interaction trigger signal relative to the predetermined 3D content.

7. The method of claim 2, the 3D live broadcast content comprises a predetermined 3D content; the 3D live broadcast screen is played in the live broadcast room on the live broadcast platform;
the step of playing the 3D live broadcast content comprises:
playing the predetermined 3D content in the 3D live broadcast content; and
in response to detecting that a user has joined the live broadcast room, displaying an avatar of the user at a predetermined position relative to the predetermined 3D content.

8. The method of claim 6, after the step of playing the predetermined 3D content in the 3D live broadcast content, the method further comprises:
in response to detecting a content adjustment signal in the live broadcast platform, adjusting and playing the predetermined 3D content.

9. The method of claim 8, the predetermined 3D content comprises a virtual 3D live broadcast object in the volumetric video; the content adjustment signal comprises an object adjustment signal;
the step of in response to detecting the content adjustment signal in the live broadcast platform, adjusting and playing the predetermined 3D content comprises:
in response to detecting the object adjustment signal in the live broadcast platform, dynamically adjusting the virtual 3D live broadcast object.

10. The method of claim 6, the 3D live broadcast screen is played in the live broadcast room on the live broadcast platform;
after the step of playing the predetermined 3D content in the 3D live broadcast content, the method further comprises:
obtaining interaction information in the live broadcast room; and
classifying the interaction information to obtain an event trigger signal in the live broadcast platform, and the event trigger signal comprises at least one of an interaction trigger signal and a content adjustment signal.

11. The method of claim 1, the step of combining the volumetric video and the 3D virtual scene to obtain the 3D live broadcast content including the live broadcast behavior and the 3D scene content comprises:
adjusting the volumetric video and the 3D virtual scene according to the combined adjustment operation of the volumetric video and the 3D virtual scene; and
in response to a combination confirmation operation, combining the volumetric video with the 3D virtual scene to obtain at least one 3D live broadcast content including the live broadcast behavior and the 3D scene content.

12. The method of claim 1, the step of combining the volumetric video and the 3D virtual scene to obtain the 3D live broadcast content comprising the live broadcast behavior and the 3D scene content comprises:
obtaining a volumetric video description parameter of the volumetric video;
obtaining a virtual scene description parameter of the 3D virtual scene;
jointly analyzing the volumetric video description parameter and the virtual scene description parameter to obtain at least one content combination parameter; and
combining the volumetric video and the 3D virtual scene according to the content combination parameter to obtain at least one 3D live broadcast content including the live broadcast behavior and the 3D scene content.

13. The method of claim 12, the step of jointly analyzing the volumetric video description parameter and the virtual scene description parameter to obtain at least one content combination parameter comprises:
obtaining a terminal parameter of a terminal used by a user in the live broadcast platform and a user description parameter of the user; and
jointly analyzing the volumetric video description parameter, the virtual scene description parameter, the terminal parameter, and the user description parameter to obtain at least one content combination parameter.

14. A live broadcast method, comprising:
in response to a live room opening operation, displaying a live broadcast room interface, and playing a 3D live broadcast screen in the live broadcast room interface, and the 3D live broadcast screen is generated according to the live broadcast method of claim 1.

15. The method of claim 14, the step of in response to the live room opening operation, displaying the live broadcast room interface comprises:
displaying a live broadcast client interface, and displaying at least one live broadcast room in the live broadcast client interface; and
in response to the live room opening operation for a target live broadcast room in the at least one live broadcast room, displaying the live broadcast room interface of the target live broadcast room.

16. The method of claim 14, the step of in response to the live room opening operation, displaying the live broadcast room interface, and playing the 3D live broadcast screen in the live broadcast room interface comprises:
in response to the live room opening operation, displaying the live broadcast room interface, and displaying an initial 3D live broadcast screen in the live broadcast room interface, and the initial 3D live broadcast screen is obtained by recording a video screen of the predetermined 3D content played in the 3D live broadcast content; and
in response to an interactive content triggering operation on the live broadcast room interface, displaying an interactive 3D live broadcast screen in the live broadcast room interface, and the interactive 3D live broadcast screen is obtained by recording a video screen of a played predetermined 3D content and a virtual interactive content triggered by the interactive content triggering operation, and the virtual interactive content belongs to the 3D live broadcast content.

17. The method of claim 16, after the step of in response to the live room opening operation, displaying the live broadcast room interface, and displaying an initial 3D live broadcast screen in the live broadcast room interface, the live broadcast method further comprises:
in response to a user joining the live broadcast room corresponding to the live broadcast room interface, displaying a subsequent 3D live broadcast screen in the live broadcast room interface, and the subsequent 3D live broadcast screen is obtained by recording a video screen of the played predetermined 3D content and an avatar of the user who joined the live broadcast room.

18. The method of claim 16, after the step of in response to the live room opening operation, displaying the live broadcast room interface, and displaying an initial 3D live broadcast screen in the live broadcast room interface, the live broadcast method further comprises:
in response to the interactive content triggering operation on the live broadcast room interface, displaying a transformed 3D live broadcast screen in the live broadcast room interface, and the transformed 3D live broadcast screen is obtained by recording a video screen of the predetermined 3D content adjusted and played, and an adjustment and playing of the 3D content is triggered by the interactive content triggering operation.

19. The method of claim 14, after the step of in response to the live room opening operation, displaying the live broadcast room interface, and playing the 3D live broadcast screen in the live broadcast room interface, the method further comprises:
in response to a voting operation for the live broadcast room interface, sending voting information to a target device, wherein a direction of a live broadcast content of a live broadcast room corresponding to the live broadcast room interface is determined by the target device according to the voting information.

20. A electronic device, comprising:
a memory, configured to store a computer program; and
a processor, configured to read the computer program stored in the memory to perform the method of claim 1.
